(19) United States
(12) Patent Application Publication
(10) Pub. No.: US 2009/0315820 A1
(43) Pub. Date: Dec. 24, 2009

(54) METHOD FOR APPLYING VOLTAGE TO PHOTO-ADDRESSABLE TYPE DISPLAY ELEMENT, POWER SUPPLY DEVICE AND DRIVING DEVICE FOR PHOTO-ADDRESSABLE TYPE DISPLAY ELEMENT

(75) Inventors: Hiroshi ARISAWA, Kanagawa (JP); Tsutomu ISHII, Kanagawa (JP); Kazuhiko NARUSHIMA, Kanagawa (JP); Seigo MAKIDA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/267,163

(22) Filed: Nov. 7, 2008

(30) Foreign Application Priority Data
Jun. 23, 2008 (JP) 2008-163179

(51) Int. Cl. G09G 3/36

(52) U.S. Cl. 345/98

(57) ABSTRACT

A method for applying a voltage to a photo-addressable type display element includes: switching between +V volt and −V volt by a switching circuit to synthesize a rectangular wave pulse of ±V volt; and applying the rectangular wave pulse of ±V volt to the photo-addressable type display element as a bias voltage. When the rectangular wave pulse is to be switched from one of +V volt and −V volt to the other, (i) the rectangular wave is grounded in the course of the switching from the one of +V volt and −V volt to the other, (ii) an output voltage of an output converter, which is not selected after the switching of the rectangular pulse, is changed to about 0 volt, and then, (iii) the rectangular wave pulse is changed to the other of +V volt and −V volt.

### CROSS-REFERENCE TO RELATED APPLICATIONS

This application is based on and claims priority under 35 USC 119 from Japanese Patent Application No. 2008-163179 filed Jun. 23, 2008.

### BACKGROUND

1. Technical Field

The invention relates to a voltage application method and a power supply device for applying a bias voltage when an image is written onto a photo-addressable type display element, and a driving device for writing the image onto the photo-addressable type display element.

2. Related Art

There have been display elements that require application of a bias voltage during a photo-addressing process.

### SUMMARY

According to an aspect of the invention, a method for applying a voltage to a photo-addressable type display element into which an image is written by applying a bias voltage while applying address light thereto, includes: switching between a dc voltage of +V volt and a dc voltage of −V volt by a switching circuit including a switching element that switches between the dc voltage of +V volt and the dc voltage of −V volt, which are output from output converters, respectively, to synthesize a rectangular wave pulse of ±V volt; and applying the rectangular wave pulse of ±V volt to the photo-addressable type display element, as the bias voltage. When the rectangular wave pulse is to be switched from one of +V volt and −V volt to the other, (i) the rectangular wave is grounded in the course of the switching from the one of +V volt and −V volt to the other, (ii) an output voltage of the output converter, which is not selected after the switching of the rectangular pulse, is changed to about 0 volt, and then, (iii) the rectangular wave pulse is changed to the other of +V volt and −V volt.

### BRIEF DESCRIPTION OF THE DRAWINGS

Exemplary embodiments of the invention will be described in detail below based on the following figures:

FIG. 1 is a circuit diagram schematically showing a state where a rectangular pulse is applied to a display element by a method for applying a voltage to a photo-addressable type display element according to an exemplary embodiment of the invention;

FIG. 2 is a circuit diagram of a switching circuit in a power supply device according to a first exemplary embodiment of the invention;

FIG. 3 is a circuit diagram of a switching circuit in a power supply device according to a second exemplary embodiment of the invention;

FIG. 4 is a time chart showing on/off of each field effect transistor and a waveform of each output voltage in time series when the power supply device of the second exemplary embodiment is operated;

FIG. 5 is a circuit diagram of a switching circuit in a power supply device according to a third exemplary embodiment of the invention;

FIG. 6 is a schematic block diagram showing a system of a fourth exemplary embodiment including a photo-addressable display element using a cholesteric liquid crystal and the entire part of a driving device;

FIG. 7 is a perspective view showing an example of the driving device for the photo-addressable type display element according to the fourth exemplary embodiment;

FIG. 8 is a perspective view showing another example of the driving device for the photo-addressable type display element according to the fourth exemplary embodiment;

FIG. 9 is a schematic block diagram showing a system according to a fifth exemplary embodiment including a photo-addressable display element having two stack units using the cholesteric liquid crystal and the entire part of a driving device;

FIG. 10 is a schematic block diagram showing a system according to a sixth exemplary embodiment including two photo-addressable display elements using the cholesteric liquid crystal and the entire part of a driving device;

FIG. 11 is a graph for explaining a switching operation of the cholesteric liquid crystal;

FIG. 12 is a circuit diagram schematically showing a state where a rectangular wave pulse is applied to the display element by a method of the related art; and

FIG. 13 is a circuit diagram showing a specific example of a switching circuit for synthesizing a rectangular wave pulse according to the related art.

### DETAILED DESCRIPTION

In order to stably driving the display elements and obtain a display image with no unevenness, a rectangular wave pulse is mainly used as a bias voltage that is applied when an image is written into the display elements. Such a rectangular wave pulse is synthesized ordinarily by outputting dc voltages of positive and negative voltage values whose absolute voltage value is equal to each other from an output converter and switching between the dc voltages by a switching circuit including plural switching elements.

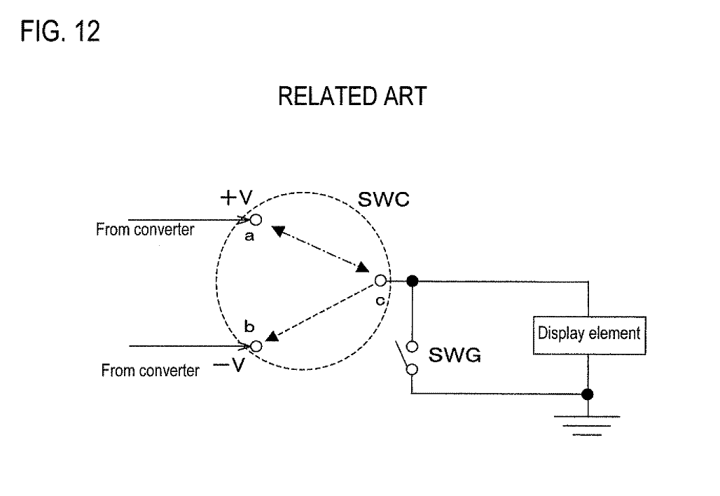

FIG. 12 is a schematic circuit diagram showing a state where the rectangular wave pulse is applied to the display element. A switching circuit SWC can appropriately switch between output voltages +V volt and −V volt from output converters. By alternately switching between the +V volt and the −V volt by the switching circuit SWC, a rectangular wave pulse to be applied to the display element is synthesized. The switching circuit SWC includes plural switching elements, and is controlled by a control circuit to switch between the +V volt and the −V volt. When a voltage application operation is finished, potentials of both the electrode layers of the display element are changed to a ground potential (reference potential) by a switching circuit SWG to finish the voltage application operation.

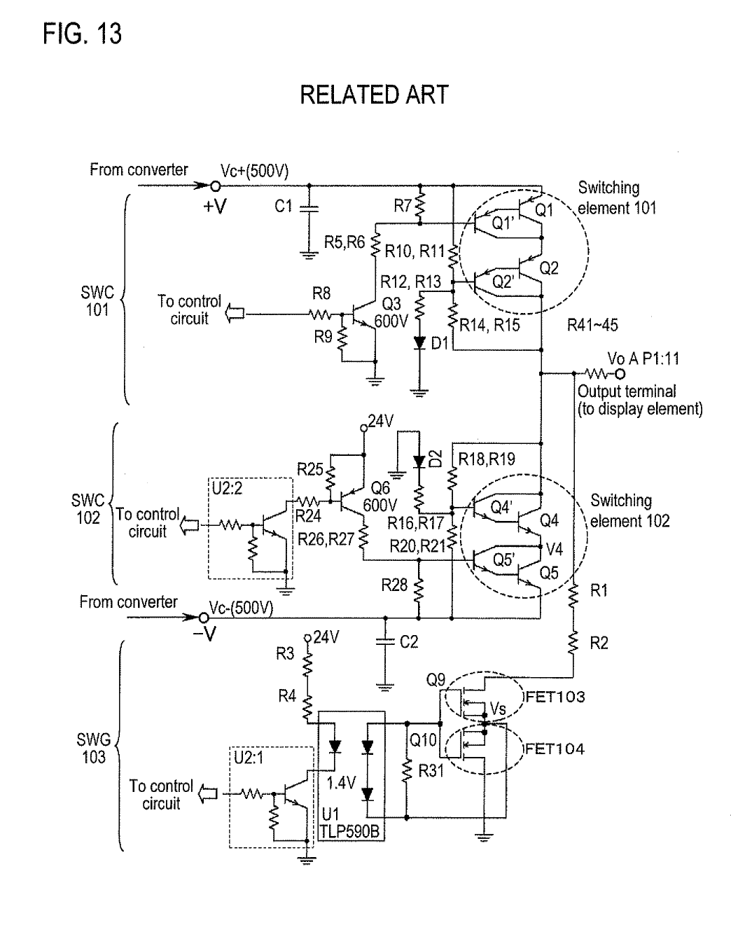

FIG. 13 is an electric circuit diagram showing one specific example of the switching circuits SWC and SWG having such functions. In FIG. 13, a circuit including a switching element 101 and a switching element 102 is the switching circuit SWC capable of suitably switching between the output voltages +V volt and −V volt from the output converters. A circuit including a switching element 103 and a switching element 104 is the switching circuit SWG for changing to the ground potential when the voltage application operation is finished.

The switching circuit SWC is configured so that a control circuit (not shown in the figure) controls the switching element 101 and the switching element 102 to alternately switch between the output voltages +V volt and −V volt from the output converter, thereby synthesizing the rectangular wave pulse and outputting the rectangular wave pulse from an output terminal. Then, when the outputting of the rectangular wave pulse is to be finished, the control circuit controls the switching element 103 and the switching element 104 included in the switching circuit SWG to lower the potential of the output terminal to the ground potential (reference potential).

When the alternately switching is made between the −V volt and the +V volt to generate the rectangular wave pulse, if one of the −V volt and the +V volt is selected, a potential difference of 2×V volt occurs between the one and the other. For example, as shown in FIG. 12, the voltage of the −V volt from the output converter is selected (an arrow mark of a broken line), the potential difference of 2×V volt occurs between a point a, which has the potential of the +V volt due to application of the voltage of the +V volt from the output converter, and a point c having the potential of the −V volt (between both arrow marks of a dashed line). Thus, the intervening switching elements, that is, the switching element 101 and the switching element 102 shown in FIG. 13 are required to have a withstanding voltage of 2×V volt.

In FIG. 13, the output voltages of the output converters are ±500 volt. Therefore, the withstanding voltage of 1,000 volt or more is required for the switching element 101 and the switching element 102. Transistors having the withstanding voltage of 600 volt are respectively connected in series to the switching element 101 and the switching element 102 so as to have the total withstanding voltage of 1,200 volt.

As a power supply device for writing an image into the display element, which is used as an electronic paper, a portable and compact one is required for rewriting in a mobile environment. However, the switching elements having a high withstanding voltage has a large size and also increases its costs.

Now, exemplary embodiments of the invention will be described in detail below with reference to the accompanying drawings.

### [Method for Applying Voltage to Photo-Addressable Type Display Element and Power Supply Device]

### <<Principle >>

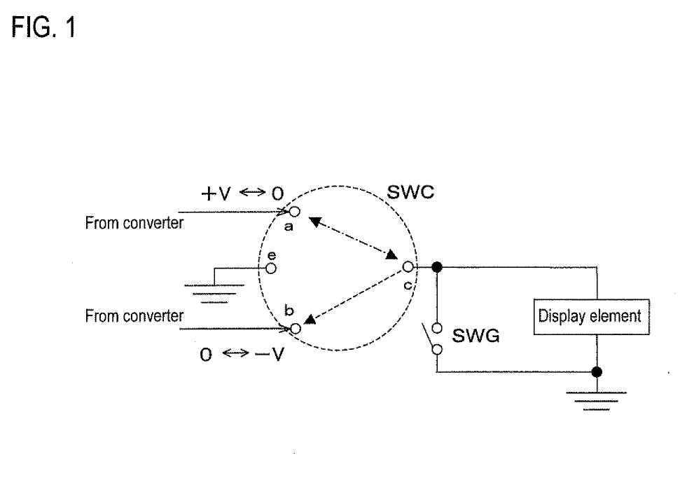

FIG. 1 is a circuit diagram schematically showing a state where a rectangular wave pulse is applied to a display element by a method for applying a voltage to a photo-addressable type display element according to an exemplary embodiment of the invention (sometimes, it is referred to simply as a “voltage application method of the exemplary embodiment” hereinafter). Here, exemplified is a structure having only one pulse generating unit (a switching circuit SWC) including a set of positive and negative switching circuits. The switching circuit SWC is configured to appropriately switch between output voltages of +V volt and −V volt from output converters. This exemplary embodiment is same as the method described with reference to FIG. 14 in that, by alternately switching between +V volt and −V volt by the switching circuit SWC, a rectangular wave pulse to be applied to a display element is synthesized.

In this exemplary embodiment, in switching from the +V volt to the −V volt (a to b) and in switching from the −V volt to the +V volt (b to a), at first, the rectangular wave pulse is grounded (e) in the course of the switching. Then, an output voltage of an output converter, which is not selected after the switching, is changed to about 0 volt, and the rectangular wave pulse is charged to −V volt or +V volt. That is, when the +V volt is to be switched to the −V volt (a to b), the output voltage (+V volt) of the output converter is changed to 0 volt, and then the output voltage (−V volt) of the output converter is switched to. On the contrary, when the −V volt is to be switched to the +V volt (b to a), the output voltage (−V volt) of the output converter is changed to 0 volt, and then the output voltage (+V volt) of the output converter is changed to.

The operation for grounding (e) the rectangular wave pulse in the course of the switching and the operation for changing the output voltage of the output converter, which is not selected after the switching are executed simultaneously in a short time for which the opposite voltage is switched to. In exemplary embodiments described later, the both operations cannot be discriminated, and accordingly, the operations become substantially the same operation.

Also, it is preferable that the short time for the switching is as short as possible, because an original rectangular waveform is less deformed. In an ordinary rectangular wave pulse, positive and negative output voltages are not sharply switched therebetween. It is preferable that a time for which the rectangular wave pulse stay in the ground state is as short as possible with respect to a time required for the switching. Although it is difficult to generally say, it is preferable that the stay time be in a range of 0 ms to 10 ms, and more preferably in a range of 0.1 ms to 1 ms. The reason why the lower limit of the preferable range is set is that if the stay time is too short, there is a possibility that an effect of changing a potential to a reference potential by grounding may not stably occur.

The voltage application method of this exemplary embodiment will be described with reference to the example shown in FIG. 1 in which the +V volt from the output converter is switched to the −V volt. In this switching, the rectangular wave pulse is grounded (e), and the output voltage of the +V volt from the output converter is simultaneously changed to 0 volt. The rectangular wave pulse is switched to the output voltage of the −V volt (b) from the output converter. Then, the point a having a potential of the +V volt drops to 0 volt, and a potential difference between the point a and a point c having the potential of the −V volt (between both arrow marks shown by a dashed line) is only V volt. This potential difference is a half of the potential difference of the related art described with reference to FIG. 14, and the withstanding voltages of intervening switching elements (such as field effect transistors) can be reduced to a half value.

The output voltage of the output converter, which has been changed to 0 volt, will be recovered to the original +V volt or −V volt until the output voltage of the output converter is selected in a next switching operation.

The output voltage of the output converter, which is not selected after the switching, may not be dropped completely to 0 volt. This is because, if the output voltage can be dropped to a certain voltage which is near 0 volt to some degree, an effect of reducing a load acting on the switching elements can be achieved.

Accordingly, even if the output voltage does not finally become 0 volt, a switching operation falls within the concept “changing to about 0 volt” irrespective of a difference in its effect so long as the output voltage is changed so as to come close to 0 volt and the effect for reducing the withstanding voltage of the switching elements occurs. Of course, if the output voltage is changed to 0 volt, the highest effect is exhibited. In order to sufficiently achieve the effect of this exemplary embodiment, it is preferable that an absolute value of a voltage after the change is 20% of the ±V volt of the initial output voltage or less, more preferably 5% or less, and furthermore preferably 1% or lower. These preferable voltages after the change fall within the “about 0 volt”.

The switching circuit SWC includes plural switching elements (FETs or the like). The switching between the +V volt and the −V volt may be made by controlling the switching elements by a control circuit. Also, changing the output voltage, before the switching, of the output converter to about 0 volt may be made by appropriately adjusting an output setting of the output converter or by providing another switching circuit.

Also, the rectangular wave pulse may be grounded in the course of the switching by the switching circuit SWG, which is used when applying the voltage is finished. It is noted that, in the exemplary embodiments described below, since the operation for grounding the rectangular wave pulse in the course of the switching is not discriminated from the operation for changing the output voltage, before the switching, of the output converter to about 0 volt, it is not necessary to carry out a special operation for grounding.

Similarly to the system of the related art, in this exemplary embodiment, when the voltage application operation is to be finished, the potentials of the both electrode layers of the display element are dropped to the ground potential (the reference potential) by the switching circuit SWG so as to finish applying the voltage to the display element.

### FIRST EXEMPLARY EMBODIMENT

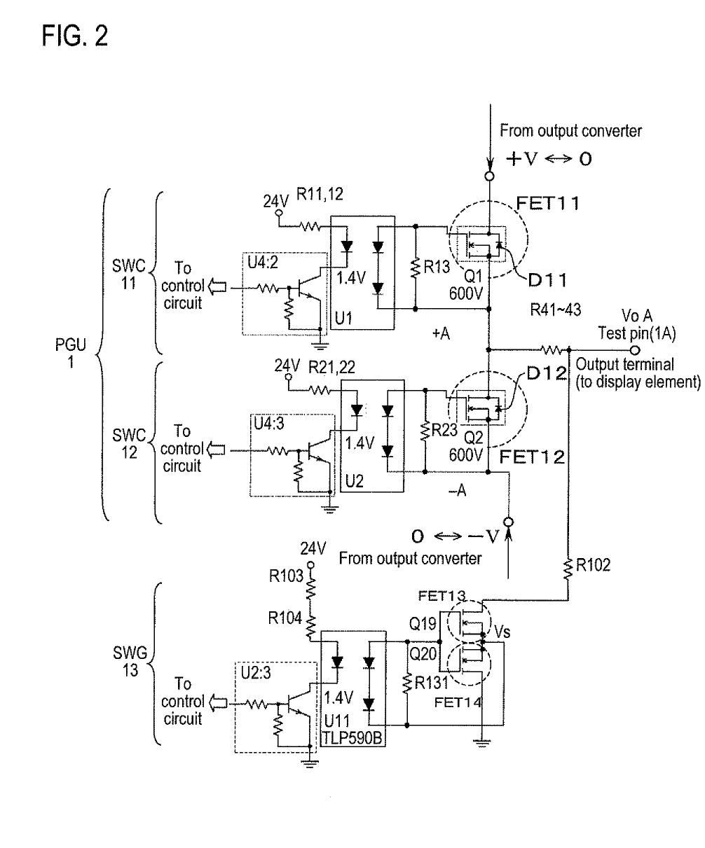

FIG. 2 shows a circuit diagram of a switching circuit in a power supply device according to a first exemplary embodiment of the invention. In FIG. 2, a circuit including a field effect transistor FET 11 as a switching element is a positive switching circuit SWC 11 for switching an output voltage of +V volt from an output converter. A circuit including a field effect transistor FET 12 as a switching element is a negative switching circuit SWC 12 for switching an output voltage of −V volt from an output converter. A pulse generating unit PGU 1 is configured to appropriately switch between the output voltages +V volt and the −V volt by the both switching circuits. The field effect transistors FET 11 and FET 12 are provided with protection diodes D11 and D12, respectively.

Further, a circuit including field effect transistors FET 13 and FET 14 as switching elements is a ground switching circuit SWG 13 that drops a potential to the ground potential when a voltage application operation is finished.

In the pulse generating unit PGU 1, the positive switching circuit SWC 11 (the field effect transistor FET 11) and the negative switching circuit SWC 12 (the field effect transistor FET 12) are controlled by a control circuit (not shown in the figure) so as to alternately switch between the output voltages +V volt and the −V volt from the output converters, for output to an output terminal. At this time, the output voltage of the output converter, which is not selected after the switching is changed to about 0 volt, and then the switching is performed.

In this exemplary embodiment, the field effect transistors FET 11 and FET 12 used for switching between the dc voltages of the +V volt and the −V volt are provided with the protection diodes. Therefore, when the field effect transistor, which is not selected after the switching, [for example, FET 11] is brought into a non-conductive state and when the output voltage [for example, +V volt] from the output converter on the non-selected side becomes about 0 volt, electric charges biased to the output terminal side flows backward to the protection diode [for example, D 11] provided in the field effect transistor to drop to the reference potential (ground potential). That is, an automatically grounded state is obtained. Therefore, the structure of this exemplary embodiment does not require a control or components for grounding, and the power supply device can be further reduced in size and in cost.

In the above description, the case of the switching from the +V volt to the −V volt is described in [ ] of the sentence. A switching operation from the −V volt to the +V volt is carried out in the same manner. In that case, [for example, FET 11], [for example, +V volt] and [for example, D 11] in the above sentence are replaced in order with [for example, FET 12], [for example, −V volt] and [for example, D 12].

As described above, a rectangular wave pulse synthesized by repeatedly carrying out the switching operation from the +V volt to the −V volt and the switching operation from the −V volt to the +V volt is output from the output terminal and used as a driving voltage of the display element. Then, when outputting the rectangular wave pulse is completed, the control circuit (not shown in the figure) controls the field effect transistors FET 13 and 14 of the ground switching circuit SWG 13 in accordance with a method of the related art to drop the potential of the output terminal to the ground potential (reference potential).

In this exemplary embodiment, the voltage ±V volt from the output converters are ±500 volt, respectively. In this exemplary embodiment having the above configuration, only a load of 500 volt which is an absolute value of the voltages from the output converters is applied to the field effect transistors FET 11 and FET 12. Accordingly, if a safety margin of 20% is estimated, the field effect transistors having the withstanding voltage of 600 volt are used as the FET 11 and the FET 12. In the system of the related art, the load of 1,000 volt is applied to the field effect transistors, and therefore, when a safety margin is similarly estimated, the withstanding voltage of 1,200 volt is required. However, the withstanding voltage of this exemplary embodiment is a half of the withstanding voltage of the related art.

As described above, when the voltage application method according to this exemplary embodiment is applied to the power supply device, the withstanding voltage required for the switching elements can be lowered. Further, a special control or components for grounding are not necessary in generating the rectangular wave pulse, and the power supply device can be greatly reduced in size and in cost.

### SECOND EXEMPLARY EMBODIMENT

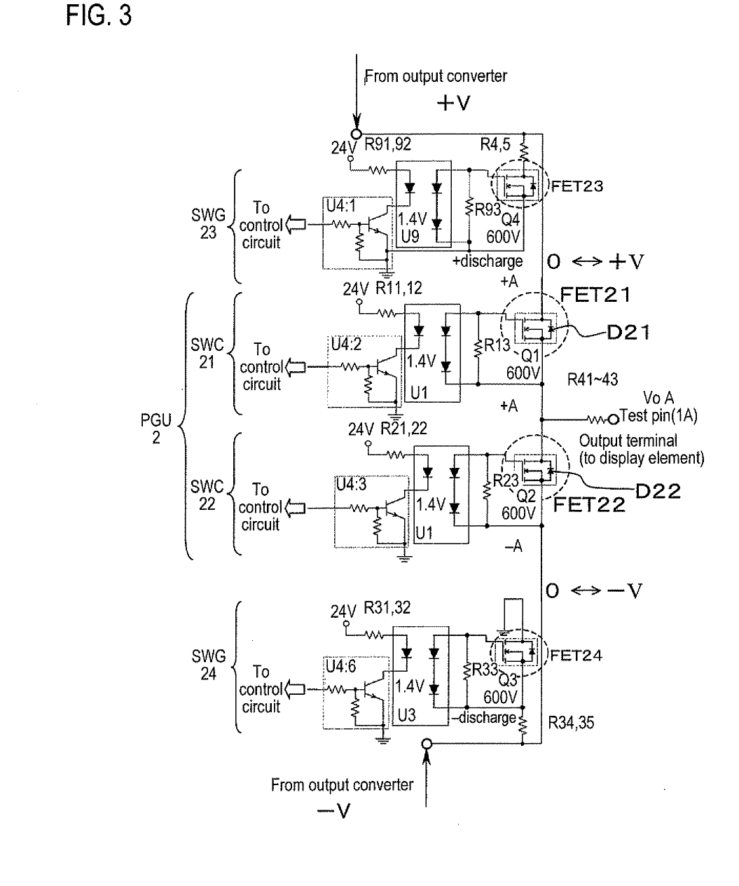

FIG. 3 shows a circuit diagram of a switching circuit in a power supply device according to a second exemplary embodiment of the invention. In this exemplary embodiment, output voltages from output converters are +V volt and −V volt that are constant. The output voltages are controlled by positive and negative power source control switching circuits including exclusive field effect transistors to switch the output voltage between 0 volt and the +V volt and switch the output voltage between 0 volt and the −V volt. In this exemplary embodiment, the positive and negative power source control switching circuits are provided. However, a ground switching circuit (SWG 13) for dropping a potential of an output terminal to the ground potential (reference potential) when a voltage application operation is finished is not provided.

In FIG. 3, a circuit including a field effect transistor FET 21 as a switching element is a positive switching circuit SWC 21 for switching an output voltage +V volt from an output converter. A circuit including a field effect transistor FET 22 as a switching element is a negative switching circuit SWC 22 for switching an output voltage −V volt from an output converter. A pulse generating unit PGU 2 is configured to appropriately switch between the output voltages +V volt and the −V volt by the both switching circuits. The field effect transistors FET 21 and FET 22 are provided with protection diodes D11 and D22, respectively.

Also, a circuit including a field effect transistors FET 23 as a switching element is a positive power source control switching circuit SWG 23 that can switch the output voltage of the positive output converter between the +V volt and about 0 volt. A circuit including a field effect transistors FET 24 as a switching element is a negative power source control switching circuit SWG 24 that can switch the output voltage of the negative output converter between the −V volt and about 0 volt.

In the pulse generating unit PGU 2, the positive switching circuit SWC 21 (the field effect transistor FET 21) and the negative switching circuit SWC 22 (the field effect transistor FET 22) are controlled by a control circuit (not shown in the figure) so as to alternately switch between the output voltages +V volt and the −V volt from the positive and negative output converters, for output to an output terminal, as in the first exemplary embodiment. At this time, like the first exemplary embodiment, the output voltage of the output converter, which is not selected after the switching, is changed to about 0 volt, and then the switching is performed.

In this exemplary embodiment, the positive power source control switching circuit SWG 23 is arranged between the positive output converter and the positive switching circuit SWC 21. The negative power source control switching circuit SWG 24 is arranged between the negative output converter and the negative switching circuit SWC 22. The positive and negative power controlling witching circuits SWG 23 and 24 makes a control so as to change the output voltage of the output converter, which is not selected after the switching, to about 0 volt. Thus, even if the output converter itself does not include a mechanism for instantaneously switching its output between the “±V volt” and “0 volt”, the switching operation can be easily carried out with the simple configuration.

Also, in this exemplary embodiment, the field effect transistors FET 21 and FET 22 used for switching between the dc voltages of the +V volt and the −V volt are provided with the protection diodes. Therefore, when the field effect transistor for the output converter, which is not selected after the switching, [for example, FET 21] is brought into a non-conductive state and when the output voltage [for example, +V volt] from the output converter on the non-selected side becomes about 0 volt, an electric charge biased to the output terminal side flows backward to the protection diode [for example, D 21] provided in the field effect transistor to drop the potential of the output terminal to the reference potential (ground potential). That is, an automatically grounded state is obtained. Therefore, the structure of this exemplary embodiment does not require a control or components for grounding, and the power supply device can be further reduced in size and in cost. The above-described explanation is the same as that when the output voltage is switched from the −V volt to the +V volt, as in the first exemplary embodiment.

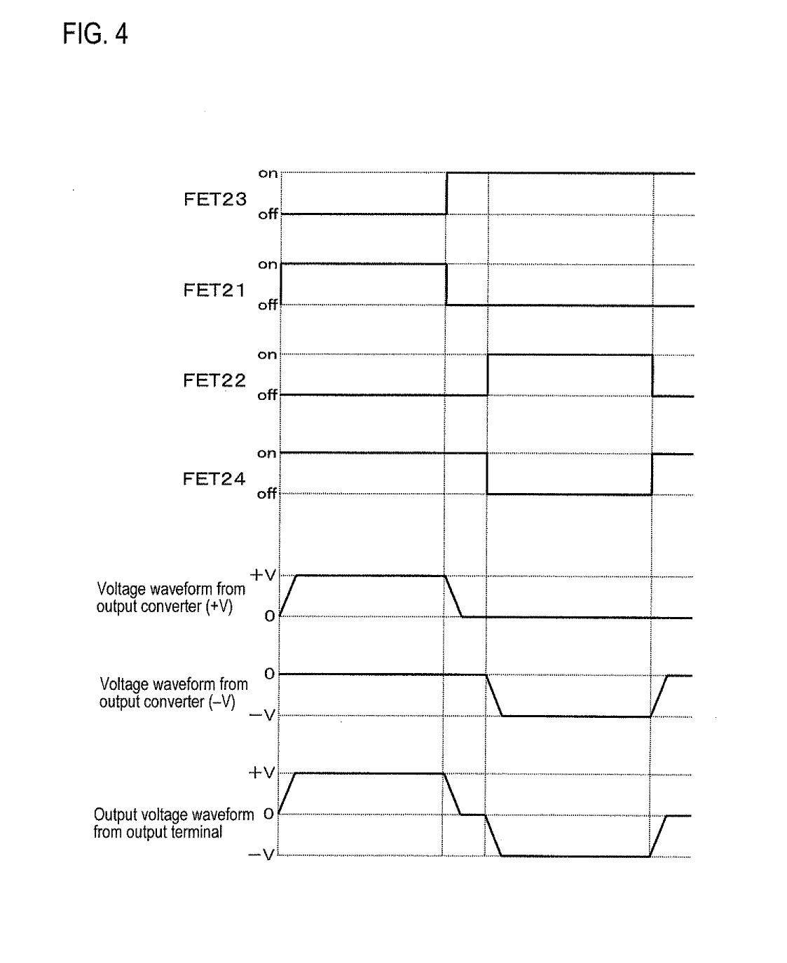

FIG. 4 is a time chart showing on/off states of the respective field effect transistors and waveforms of the respective output voltages when the power supply device of this exemplary embodiment is operated. Referring to the time chart shown in FIG. 4, an explanation will be given below. At first, under a state that the field effect transistor FET 23 is turned off and the field effect transistor FET 24 is turned on, a voltage is output from the output converter for outputting the output voltage of the +V volt, and the field effect transistor FET 21 is turned on at the same time. The field effect transistors FET 23 and FET 24 have functions for directly outputting the voltages from the output converters when the transistors are turned off and for switching the voltages from the output converters to 0 volt when the transistors are turned on. The voltage from the output converter reaches the +V volt as a peak with a little time lag. This waveform is reflected on the waveform of the output voltage from the output terminal as it is.

Then, after a time for forming a predetermined pulse width has elapsed, the field effect transistor FET 23 is turned on and the field effect transistor FET 21 is turned off. At this time, the voltage from the positive output converter is simultaneously dropped to 0 volt. Then, the output voltage from the output terminal also becomes 0 volt with a little time lag.

Then, the field effect transistor FET 24 is turned off, and the voltage is output from the negative output converter for outputting the output voltage of the −V volt. Also, the field effect transistor FET 22 is turned on. The voltage from the negative output converter reaches the −V volt as a peak with a little time lag. This waveform is reflected on the waveform of the output voltage from the output terminal as it is.

Similarly to the case where the +V volt is output, after a time for forming the predetermined pulse width has elapsed, the field effect transistor FET 24 is turned on, and the field effect transistor FET 22 is turned off. At this time, the voltage from the negative output converter is simultaneously dropped to 0 volt. Then, the output voltage from the output terminal also becomes 0 volt with a little time lag. The above-described driving cycles are repeated so as to synthesize the rectangular wave pulse of ±V volt.

As described above, the rectangular wave pulse synthesized by repeatedly carrying out the switching operation from the +V volt to the −V volt and the switching operation from the −V volt to the +V volt is output from the output terminal and used as a driving voltage of the display element. Then, when outputting the rectangular wave pulse is completed, the positive power source control switching circuit SWG 23 and the negative power source control switching circuit SWG 24 are controlled by the control circuit (not shown in the figure) to drop the potential of the output terminal to the ground potential (reference potential).

In this exemplary embodiment, the voltage ±V volt from the output converters is ±500 volt. In this exemplary embodiment having the configuration described above, only a load of 500 volt which is an absolute value of the voltages from the output converters is applied to the field effect transistors FET 21 and FET 22. Accordingly, if a safety margin of 20% is estimated, the field effect transistors having the withstanding voltage of 600 volt are used as the FET 21 and the FET 22. In the system of the related art, the load of 1,000 volt is applied to the field effect transistors, and therefore, when a safety margin is similarly estimated, the withstanding voltage of 1,200 volt is required. However, the withstanding voltage of this exemplary embodiment is a half of withstanding voltage of the related art.

As described above, when the voltage application method according to this exemplary embodiment is applied to the power supply device, the withstanding voltage required for the switching elements can be lowered. Further, a special control or components for grounding are not necessary in generating the rectangular wave pulse. The outputs from the output converters can be suitably and instantaneously switched between “±V volt” and “0 volt” with a simple configuration. Further, the power supply device can be greatly reduced in size and in cost.

### THIRD EXEMPLARY EMBODIMENT

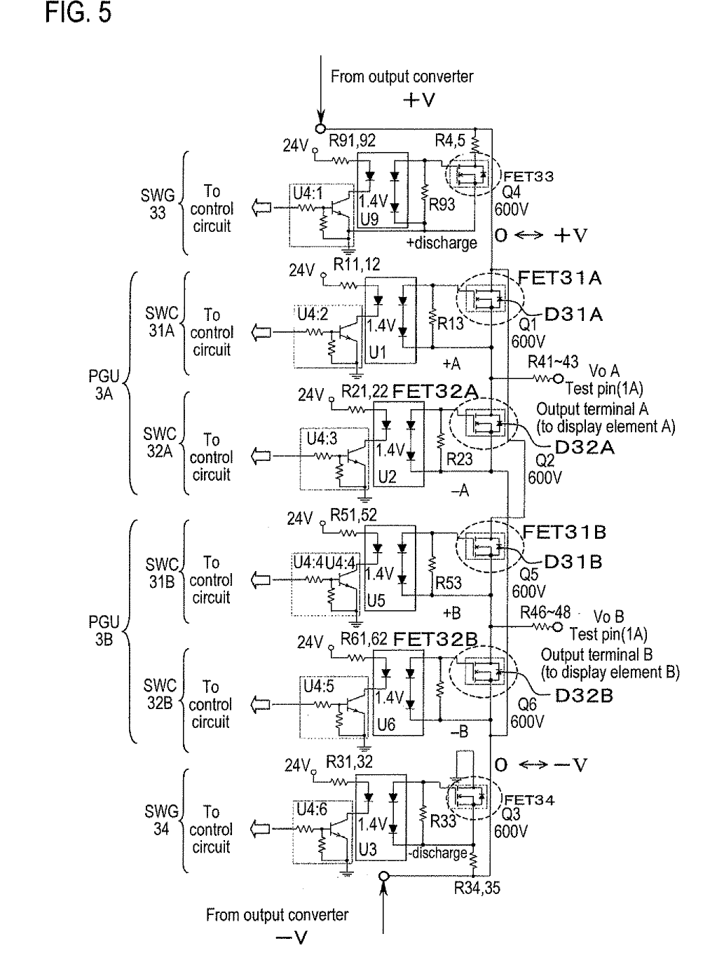

FIG. 5 shows a circuit diagram of a switching circuit in a power supply device according to a third exemplary embodiment of the invention. In this exemplary embodiment, two pulse generating units PGU 3A and PGU 3B having the same structure as that of the pulse generating unit PGU 2 of the second exemplary embodiment are arranged in parallel. Output terminals A and B are connected to the pulse generating units PGU 3A and PGU 3B, respectively. Individual display elements or different stack units of a single display element may be connected to the output terminals A and B, respectively, and a driving voltage can be applied to the two stack units simultaneously.

Further, like the second exemplary embodiment, output voltages +V volt and −V volt from output converters are constant. Positive and negative power source control switching circuits SWG 33 and SWG 34 include field effect transistors FET 33 and FET 34 as switching elements for switching the output voltage between 0 volt and the +V volt and switching the output voltage between 0 volt and the −V volt, respectively. No ground switching circuit (SWG 13) for dropping a potential of an output terminal to the ground potential (reference potential) when the voltage application operation is completed is provided. Since the positive and negative power source control switching circuits SWG 33 and SWG 34 output the driving voltages having the same waveform to the output terminals A and B simultaneously, a timing of switching the output between “±V volt” and “0 volt” is the same in the two pulse generating units PGU 3A and PGU 3B. The output voltages to both the pulse generating units PGU 3A and PGU 3B are switched by the positive and negative power source control switching circuits SWG 33 and SWG 34 simultaneously. That is, it is not necessary to provide the positive and negative power source control switching circuits for each of the pulse generating units PGU 3A and the PGU 3B.

In the pulse generating unit PGU 3A shown in FIG. 5, a circuit including a field effect transistor FET 31A as a switching element is a positive switching circuit SWC 31A that switches the output voltage +V volt from the positive output converter A circuit including a field effect transistor FET 32A as a switching element is a negative switching circuit SWC 32A that switches the output voltage −V volt from the negative output converter. The pulse generating unit PGU 3A is configured to appropriately switch between the output voltages +V volt and the −V volt by the both switching circuits. The field effects transistors FET 31A and FET 32A are provided with protection diodes D31A and D32A.

The pulse generating unit 3B is also configured in the same way as that of the pulse generating unit 3A (if “A” at the end of each reference numeral in the above paragraph is replaced with “B”, the above paragraph becomes description on the configuration of the pulse generating unit PGU 3B.).

A circuit including the field effect transistor FET 33 is the positive power source control switching circuit SWG 33 that can switch the output voltage of the positive output converter between the +V volt and about 0 volt. A circuit including the field effect transistor FET 34 is the negative power source control switching circuit SWG 34 that can switch the output voltage of the negative output converter between the −V volt and about 0 volt.

Since the pulse generating units PGU 3A and PGU 3B carry out the same operations at the same timing, the both pulse generating units PGU 3A and PGU 3B will be collectively described below.

In the pulse generating units PGU 3A and 3B, the positive switching circuits SWC 31A and 31B (the field effect transistors FET 31A and 31B) and the negative switching circuits SWC 32A and 32B (the field effect transistors FET 32A and 32B) are controlled by a control circuit (not shown in the figure) so as to alternately switch between the output voltages +V volt and the −V volt from the output converters for output to the output terminals A and B, as in the second exemplary embodiment. At this time, like the second exemplary embodiment, the output voltage of the output converter, which is not selected after the switching, is changed to about 0 volt, and then the switching is performed.

In this exemplary embodiment, the positive power source control switching circuit SWG 33 is arranged between the positive output converter and the positive switching circuits SWC 31A and 31B. Also, the negative power source control switching circuit SWG 34 is arranged respectively is arranged between the negative output converter and the negative switching circuits SWC 32A and 32B. The positive and negative power source control switching circuits SWG 33 and 34 control the positive and negative output voltages to the both pulse generating units PGU 3A and PGU 3B.

The positive and negative power controlling witching circuits SWG 33 and 34 make a control so as to change the output voltage of the output converter, which is not selected after the switching, to about 0 volt. Thus, even if the output converter itself does not include a mechanism for instantaneously switching the output between the “±V volt” and “0 volt”, the switching operation can be easily carried out with a simple configuration. Further, the field effect transistors and the switching circuits used for this control may be commonly used for the pulse generating units, which operate simultaneously. Therefore only a pair of positive and negative field effect transistors and switching circuits may be adequately required irrespective of the number of the pulse generating units. Thus, the number of electronic elements can be reduced, and the switching operation can be easily realized with the simple configuration.

Also, in this exemplary embodiment, the field effect transistors FET 31A and 31B and FET 32A and 32B used for switching between the dc voltages of the +V volt and the −V volt are provided with the protection diodes. Therefore, when the field effect transistors [for example, FET 31A, 31B], which are not selected after the switching, are brought into a non-conductive state, and the output voltage [for example, +V volt] from the output converter on the non-selected side becomes about 0 volt, an electric charge biased to the output terminal side flows backward to the protection diodes [for example, D 31A, 31B] provided in the field effect transistors to drop the potential of the output terminal to the reference potential (ground potential). That is, an automatically grounded state is obtained. Therefore, the configuration of this exemplary embodiment does not require a control or components for grounding, and the power supply device can be further reduced in size and in cost. The above description is the same as that when the output voltage is switched from the −V volt to the +V volt as in the first exemplary embodiment and the second exemplary embodiment.

As described above, the rectangular wave pulses synthesized by repeatedly carrying out the switching operation from the +V volt to the −V volt and the switching operation from the −V volt to the +V volt in the pulse generating units PUG 3A and PUG 3B are output from the output terminals A and B and used as driving voltages of the display elements. At this time, the driving voltage may be simultaneously applied to plural stack units of the display element, which includes the plural stack units therein and which can form, for example, a full color image. Or, the driving voltage may be applied so as to simultaneously drive plural display elements each having a single stack unit.

Then, when outputting the rectangular wave pulse is completed, the positive power source control switching circuit SWG 33 and the negative power source control switching circuit SWG 34 are controlled by the control circuit (not shown in the figure) to drop the potentials of the output terminals to the ground potential (reference potential) as in the second exemplary embodiment.

In this exemplary embodiment, the voltage ±V volt from the output converters are ±500 volt. In this exemplary embodiment having the above configuration, only a load of 500 volt which is an absolute value of the voltages from the output converters is applied to the field effect transistors FET 31A and 31B and FET 32A and 32B. Accordingly, if a safety margin of 20% is estimated, the field effect transistors having the withstanding voltage of 600 volt are used as the FET 31A and 311 and the FET 32A and 32B. In the system of the related art, the load of 1,000 volt is applied to the field effect transistors, and therefore, when a safety margin is similarly estimated, the withstanding voltage of 1,200 volt is required. However, the withstanding voltage of this exemplary embodiment is a half of the withstanding voltage of the related art.

As described above, when the voltage application method according to this exemplary embodiment is applied to a power supply device, the withstanding voltage required for the switching elements can be lowered. Further, a special control or components for grounding are not necessary in generating the rectangular wave pulse, and the output from the output converter can be suitably and instantaneously switched between “±V volt” and “0 volt” by a simple configuration, and the power supply device can be greatly reduced in size and in const. Further, since the driving voltages can be simultaneously applied to the plural stack units in the single or plural display elements, the number of electronic elements can be further reduced, and the power supply device can be further reduced in size and in cost as compared with the case where the driving voltages are separately applied.

As described above, the method for applying a voltage to a photo-addressable type display element and the power supply device according to the first to the third exemplary embodiments are described. However, the invention is not limited thereto. For example, in the above-above-described exemplary embodiments, only the configurations in which the number of the pulse generating units is one or two are exemplified. However, it is to be understood that the number of the pulse generating units may be three or more. If the number of the pulse generating units is three or more in the same configuration as that of the third exemplary embodiment, only one pair of positive and negative power source control switching circuits is adequately required like the above-described exemplary embodiments. Therefore, the number of electronic elements per the synthesized driving voltage can be further reduced.

A person with ordinary skill in the art can suitably modify the invention in accordance with other well-known knowledge. Even if the invention is modified, it is to be understood that the modifications falls under the scope of the invention so long as the modifications include a driving method of the invention and/or the configuration the driving device of the invention.

### [Driving Device for Photo-Addressable Type Display Element]

The above-described method for applying a voltage to a photo-addressable type display element and the power supply device according to the exemplary embodiments may be used when a bias voltage is applied to various kinds of photo-addressable type display elements into which an image is written by applying address light thereto while applying the bias voltage thereto. The configuration of the photo-addressable type display element (hereinafter may be simply referred to as a “display element”) to which the rectangular wave pulse is applied as the bias voltage is not limited to specific one.

Now, a display element having various kinds of excellent features such as a memory property without a power supply, a bright display and a portability and having a single stack unit using a cholesteric liquid crystal is taken as an example, and a driving device using the voltage application method and the power supply device according to the exemplary embodiments, that is, a driving device for the photo-addressable type display element according to the exemplary embodiments (may be simply referred to as a “driving device”) will be described below. The following description is merely exemplary, and the invention is not limited to the following configuration.

### FOURTH EXEMPLARY EMBODIMENT

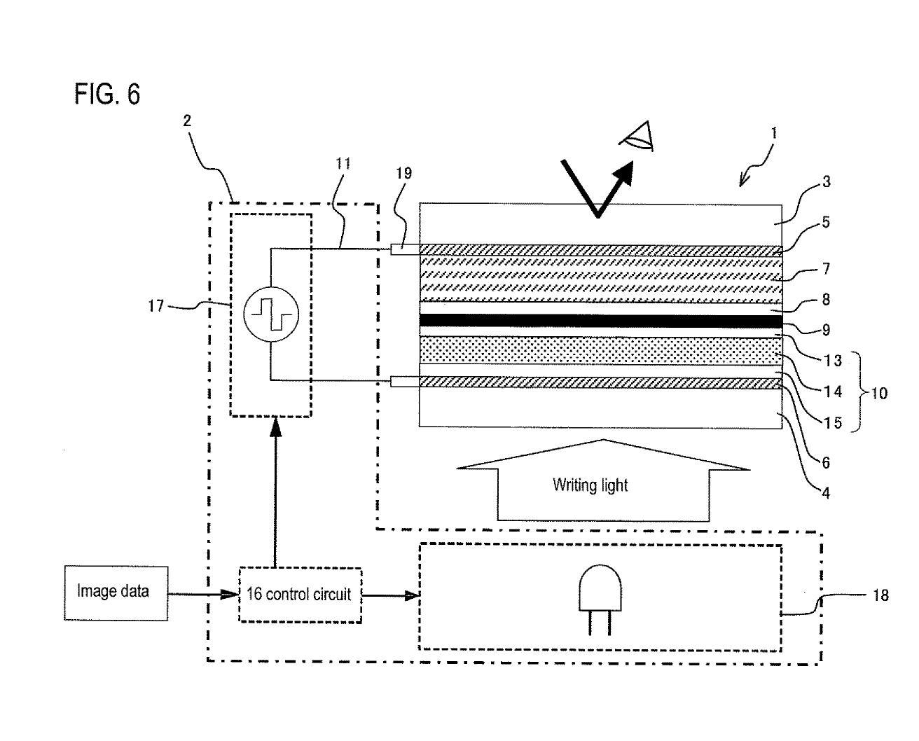

FIG. 6 is a schematic block diagram of a system, according to a fourth exemplary embodiment, including (i) the photo-addressable type display element using the cholesteric liquid crystal and (ii) the entire part of the driving device. As shown in FIG. 6, the system of this exemplary embodiment includes the photo-addressable type display element 1 and the driving device (the driving device for the photo-addressable type display element) 2 for driving (writing an image into) the display element 1. The driving device 2 includes a power supply device 17 (an example of a voltage applying unit), a light irradiation device 18 (an example of a light irradiation unit) and a control circuit 16 for controlling operations of them.

### <Photo-Addressable Type Display Element>

In the exemplary embodiment, the display element 1 (an example of the photo-addressable type display element) has a substrate 3, an electrode 5, a display layer 7, a laminate layer 8, a coloring layer 9 (an example of a shading layer), an organic photosensitive layer 10 (an example of a photoconductive layer), an electrode 6 (an example of electrode layer), and a substrate 4, which are stacked in order from the display surface. The display element 1 includes a single stack unit in which the photosensitive layer 10 (the example of the photoconductive layer) and the display layer 7 are stacked and sandwiched between the pair of electrodes 5 and 6 (the example of the electrode layers).

### (Substrate)

The substrates 3 and 4 are members intended for holding the functional layers inside and maintaining the structure of the display element. Each of the substrates 3 and 4 is a sheet-shaped substance having a strength enduring an external force and may have flexibility. As a specific material, an inorganic sheet (for example, glass, silicon), a polymer film (for example, polyethylene terephthalate, polysulfone, polyethersulfone, polycarbonate, polyethylene naphthalate), etc., can be named. At least, the substrate 3 on the display-surface side has a function of transmitting display light. A known functional film such as a dirt prevention film, a wear resistance film, a light reflection prevention film and/or a gas barrier film may be formed on an outside surface of the substrate 3.

### (Electrode)

The electrodes (electrode layers) 5 and 6 are members intended for applying a bias voltage, which is applied from a power supply device 17, to the functional layers in the display element 1. Specifically, a conductive thin film formed of metal (for example, gold, silver, copper, iron, aluminum), a metal oxide (for example, indium oxide, tin oxide, indium tin oxide (ITO)), carbon, a complex having them dispersed in a polymer, a conductive organic polymer (for example, polythiophen base, polyaniline base), etc., can be named as the electrodes. The electrodes 5, 6 may be formed on those surfaces with a known functional film such as an adhesion improvement film, a light reflection prevention film and/or a gas barrier film.

### (Display Layer)

In this exemplary embodiment, any display layer may be used so long as the display layer has a function of modulating a reflection/transmission state of incident light depending on an electric field and has a property capable of holding a selected state with no electric field. For example, when a change of orientation of a liquid crystal is used, various kinds of liquid crystal elements having different optical effects may be adopted, such as a bistable type twist nematic liquid crystal, a liquid crystal using the change of a polarized state such as a surface stabilizing ferroelectric liquid crystal, a liquid crystal using the change of a light scattering state such as a memory type polymer dispersion liquid crystal, a liquid crystal of a system using the change of a light absorption state such as a guest host liquid crystal obtained by mixing a two color type coloring matter with to the above-described liquid crystals, a liquid crystal of a system using the change of a light interference state such as a memory type cholesteric (chiral nematic) liquid crystal, etc. In this exemplary embodiment, the liquid crystal of the last one is exemplified.

It is preferable that the display layer has a structure that is not deformed relative to an external force such as a bending or a pressure is preferable.

In the display layer of this exemplary embodiment, a liquid crystal layer of a self-holding type liquid crystal complex made up of cholesteric liquid crystal and a transparent resin is formed as the light modulation layer. That is, it is a liquid crystal layer which does not require a spacer, because it has a self-hold property as a complex. In the exemplary embodiment, cholesteric liquid crystal is dispersed in a polymer matrix (transparent resin) although not shown in the figure.

In this exemplary embodiment, it is not necessary that the display layer is a liquid crystal layer of a self-holding type liquid crystal complex. The display layer may be formed of liquid crystal only, of course.

The cholesteric liquid crystal has a function of modulating a reflection/transmission state of specific color light in incident light and has liquid crystal molecules, which are oriented with helically twisted. The cholesteric liquid crystal executes interference reflection of specific light dependent on the helical pitch, of light incident from the helical axis direction. An electric field can change the orientation to thereby change the reflection state. When the light modulation layer is formed of a self-holding type liquid crystal complex, the cholesteric liquid crystal may be placed as a monolayer densely with uniform drop sizes.

As specific liquid crystal that can be used as cholesteric liquid crystal, a steroid base cholesterol derivative or nematic liquid crystal or smectic liquid crystal (for example, Schiff base, azo base, azoxy base, benzoate base, biphenyl base, terphenyl base, cyclohexyl carboxylate base, phenyl cyclohexane base, biphenyl cyclohexane base, pyrimidine base, dioxane base, cyclohexyl cyclohexane ester base, cyclohexyl ethane base, cyclohexane base, tran base, alkenyl base, stilbene base, polycyclic base) or substance provided by adding to a mixture thereof, a chiral agent (for example, steroid base cholesterol derivative, Schiff base, azo base, ester base, biphenyl base), and the like can be named.

The helical pitch of the cholesteric liquid crystal is adjusted according to the chemical structure of a liquid crystal molecule and the addition amount of a chiral agent to the nematic liquid crystal. For example, to set the display color to blue, green, or red, the center wavelength of selective reflection is placed in the range of 400 nm to 500 nm, the range of 500 nm to 600 nm, or the range of 600 nm to 700 nm. To compensate for the temperature dependency of the helical pitch of the cholesteric liquid crystal, a known technique of adding a plurality of chiral agents different in twist direction or showing inverse temperature dependency may be used.

As a form wherein the display layer 7 forms a self-holding type liquid crystal complex made up of cholesteric liquid crystal and a polymer matrix (transparent resin), a PNLC (Polymer Network Liquid Crystal) structure wherein network resin is contained in the continuous texture of the cholesteric liquid crystal or a PDLC (Polymer Dispersed Liquid Crystal) structure wherein the cholesteric liquid crystal is dispersed like droplets in the skeleton of the polymer (containing a polymer dispersed microencapsulated liquid crystal structure) can be used and the PNLC structure or the PDLC structure is adopted, whereby an anchoring effect is produced on the interface between the cholesteric liquid crystal and the polymer and the hold state of the planar texture or the focal conic texture in no electric field can be more stabilized.

The PNLC structure and the PDLC structure can be formed according to a known method of executing texture separation of polymer and liquid crystal, for example, a PIPS (Polymerization Induced Texture Separation) method of mixing a polymer precursor polymerized by heat, light, an electron ray, etc., such as acrylic base, thiol base, or epoxy base, and liquid crystal and polymerizing from the state of a uniform texture for texture separation, an emulsion method of mixing a polymer low in liquid crystal solubility such as polyvinyl alcohol and liquid crystal and executing agitation suspension for dispersing the liquid crystal in the polymer like droplets, a TIPS (Thermally Induced Texture Separation) method of mixing a thermoplastic polymer and liquid crystal and cooling from a heated state to a uniform texture for texture separation, an SIPS (Solvent Induced Texture Separation) method of dissolving a polymer and liquid crystal in a solvent of chloroform, etc., and evaporating the solvent for texture separation of the polymer and the liquid crystal, or the like, but the method is not limited.

The polymer matrix has a function of holding cholesteric liquid crystal and suppressing fluid flow of liquid crystal (image change) caused by deformation of a display element, and a polymer material not dissolving in liquid crystal material and with liquid not mutually solved in liquid crystal as a solvent is used preferably. It is desirable that a material having a strength enduring an external force and showing high transmission at least for reflected light and address light should be used as the polymer matrix.

As the material that can be adopted as the polymer matrix, a water-soluble polymer material (for example, gelatin, polyvinyl alcohol, cellulose derivative, polyacrylic polymer, ethyleneimine, polyethylene oxide, polyacrylamide, polystyrene sulfonate, polyamidine, isoprene base sulfonic acid polymer) or a material that can be put into water-based emulsion (for example, fluorocarbon resin, silicone resin, acrylic resin, urethane resin, epoxy resin), etc., can be named.

### (Organic Photosensitive Layer)

The organic photosensitive layer (photoconductive layer) 10 is a layer having an internal photoelectric effect and having such a characteristic that its impedance characteristic changes in response to an irradiation intensity of address light. In the alternating current (AC) operation, a symmetric driving with respect to the address light may be adopted. In this case, charge generation layers (CGL) are stacked on and below a charge transport layer (CTL) (three-layer structure). In this exemplary embodiment, as the organic photosensitive layer 10, an upper charge generation layer 13, a charge transport layer 14 and a lower charge generation layer 15 are stacked in order from an upper layer in FIG. 6.

The charge generation layers 13, 15 are layers having a function of absorbing address light and generating a photocarrier. An amount of photocarriers that flows in a direction from the electrode 5 on the surface side to the electrode 6 on the writing surface side mainly depends on the charge generation layer 13, and an amount of photocarriers that flows in a direction from the electrode 6 on the writing surface side to the electrode 5 on the surface side mainly depends on the charge generation layer 15. The charge generation layers 13, 15 may be a layer capable of absorbing address light, generating an exciton, and efficiently separating to a free carrier in CGL or on the interface between CGL and CTL.

The charge generation layers 13, 15 may be formed by a dry method of directly forming a film of a charge generation material (for example, metal or non-metal phthalocyanine, squalium compound, azulenium compound, perylene pigment, indigoid pigment, azo pigment such as bis and tris, quinacridone pigment, pyrrolo pyrrole dye, polycyclic quinone pigment, reduced cyclic aromatic based pigment such as dibromo ant anthrone, cyanine dye, xanthene pigment, charge transfer complex such as polyvinyl carbazole and nitro fluorine, eutectic complex made up of pyrylium salt dye and polycarbonate resin) or a wet applying method of preparing application liquid by dispersing or dissolving the charge generation materials in a proper solvent together with a polymer binder (for example, polyvinyl butyral resin, polyallylate resin, polyester resin, phenol resin, vinyl carbazole resin, vinyl formal resin, partial denaturation vinyl acetal resin, carbonate resin, acrylic resin, vinyl chloride resin, styrene resin, vinyl acetate resin, vinyl acetate resin, silicone resin, etc.,), applying the liquid, and drying it to form a film.

The charge transport layer 14 is a layer into which the photocarrier generated in the charge generation layer 15 is injected, and has a function of drifting the photocarrier in a direction of an electric field applied by a bias signal.

Preferably, in the charge transport layer 14, free carrier is injected from the charge generation layer 15 efficiently (the charge transport layer 14 may have an ionization potential close to that of the charge generation layer 15) and the injected free carrier makes a hopping move at high speed as much as possible. To increase the impedance at the dark time, preferably dark current based on heat carrier is lower.

The charge transport layer 14 may be formed by preparing a substance obtained by dispersing or dissolving a low-molecular hole transport material (for example, trinitro fluorine base compound, polyvinyl carbazole base compound, oxadiazole base compound, hydrazone base compound such as benzyl amino base hydrazone or quinoline base hydrazone, stilbene base compound, triphenyl amine base compound, triphenyl methane base compound, benzidine base compound) or low-molecular electron transport material (for example, quinone base compound, tetra cyano kino dimetan base compound, fluon compound, xanthone base compound, benzophenone base compound) in a proper solvent together with a polymer binder (for example, polycarbonate resin, polyallylate resin, polyester resin, polyimide resin, polyamide resin, polystyrene resin, silicon-containing crosslink type resin, etc.,) or a substance obtained by dispersing or dissolving a material provided by the polymerized hole transport material or polymerized electron transport material in a proper solvent, applying the substance, and drying it.

### (Coloring Layer)

The coloring layer (shading layer) 9 is a layer intended to optically separate address light and incident light during writing for preventing malfunction caused by mutual interference and to optically separate external light incident from the non-display-surface side of the display element and a display image during displaying for preventing degradation of the image quality. It is noted that the coloring layer 9 is not an indispensable component in this exemplary embodiment. However, for the purpose of enhancing property of the display element 1, it is desired to provide the color layer 9. From its purpose, the coloring layer 9 is required to have a function of absorbing at least light in the absorption wave range of the charge generation layer and light in the reflected wave range of the display layer.

The coloring layer 9 specifically can be formed by a wet applying method of preparing application liquid by dispersing or dissolving inorganic pigment (for example, cadmium base, chromium base, cobalt base, manganese base, caron base) or organic dye or organic pigment (for example, azo base, anthraquinone base, indigo base, triphenylmethane base, nitro base, phthalocyanine base, perylene base, pyrrolo pyrrole base, quinacridone base, polycyclic quinone base, squarerium base, azurenium base, cyanine base, pyririum base, anthrone base) in a proper solvent together with a polymer binder (for example, polyvinyl alcohol resin, polyacrylic resin, etc.,), applying the liquid, and drying it to form a film.

### (Laminate Layer)

The laminate layer 8 is a layer intended to absorb roughness and to adhere when the functional layers formed inside the upper and lower substrates 3 and 4 are put on each other. It is noted that the laminate layer 8 is not an indispensable component in the exemplary embodiment. The laminate layer 8 is formed of a thermoplastic organic material, a thermosetting organic material, or an organic material of mixed type thereof. A material capable of causing the display layer 7 and the coloring layer 9 closely adhering or adhering to each other by heat and pressure is selected. The laminated layer 8 is required to have at least a transmission property of incident light.

As an appropriate material for the laminate layer 8, an adhesive polymeric material (for example, polyethylene base, polypropylene base, polyurethane base, epoxy base, acrylic base, rubber base, silicone base) can be named.

### (Contact Terminal)

A contact terminal 19 is a member for coming in electric contact with a conductive wire 11 to which a voltage is supplied from the power supply device 17, and the display element 1 (electrode layer 5, 6). A material having high electric conductivity and having small contact resistance with respect to the electrode layer 5, 6 and the conductive wire 11 is selected. The contact terminal 19 may have such a structure that can be detached from the electrode layer 5, 6 so that the display element 1 and the driving apparatus 2 can be separated from each other (in place or in addition, the contact terminal 19 may be detachable from the driving apparatus 2).

As the contact terminal 19, a terminal which is made of metal (for example, gold, silver, copper, iron, aluminum), carbon, a complex having them dispersed in a polymer, a metal oxide (for example, indium oxide, tin oxide, indium tin oxide (ITO)), carbon, a complex having them dispersed in a polymer, a conductive organic polymer (for example, polythiophen base, polyaniline base), etc., and which has a clip connector shape for clipping the electrode can be named.

### <Driving Apparatus>

In this exemplary embodiment, the driving apparatus 2 (the driving apparatus for a photo-addressable type display element) is a device for writing an image into the display element 1. The driving apparatus 2 has a light irradiation device (light irradiation unit) 18 for applying address light to the display element 1 and the power supply device (voltage application unit) 17 for applying a bias voltage to the display element 1 as main components. The driving apparatus 2 also includes a control circuit 16 for controlling operation of the components 17 and 18.

### (Light Irradiation Device)

The light irradiation device (light irradiation unit) 18 is not limited to a specific device so long as it has a function of applying imagewise address light pattern to the display element 1 and can apply any desired light image pattern (spectrum, strength, spatial frequency) to the display element 1 (particularly, the organic photosensitive layer 10) based on an input signal from the control circuit 16. It is not necessary that an area to be irradiated with light is the entire write surface of the display element 1, and the area may be within a range where the display layer is formed, of course, and needs only to be in an area to be written (writing area).

The address light irradiated by the light irradiation device 18 satisfying the following conditions may be selected. However, the address light is not limited thereto.

Spectrum: Energy in the absorption wave range of the organic photosensitive layer 10 may be large as much as possible.

Irradiation intensity: Such an intensity that at the bright time, a voltage applied to the display layer 7 becomes equal to or greater than a driving threshold voltage due to voltage division with the organic photosensitive layer 10 and orientation of the liquid crystal in the display layer 7 is changed and that at the dark time, the applied voltage becomes less than the voltage of the upper or lower threshold value.

The address light applied by the light irradiation device 18 may be light having a peak intensity in the absorption wave range of the organic photosensitive layer 10 and a narrow bandwidth as much as possible.

As the light irradiation device 18, specifically the following can be named:

(1-1) A section capable of forming any desired two-dimensional light emission pattern by scanning operation, such as one formed by arranging light sources one-dimensionally in an array shape or one formed by combining a light source and a polygon mirror
(1-2) A combination of (i) a uniform light source such as one formed by arranging light sources in an array shape or a combination of a light source and a light guide plate and (ii) a light adjustment element for generating a light pattern (for example, LCD, photo mask, etc.,)
(2) Self-luminous type display such as one formed by arranging light sources in a plane shape (for example, CRT, PDP, EL, light emitting diode, FED, SED)
(3) A combination of (i) (1-1), (1-2), or (2) and (ii) an optical element (for example, microlens array, cell hook lens array, prism array, viewing angle adjustment sheet)

### (Power Supply Device)

The power supply device (voltage application unit) 17 may be any so long as it has a function of applying a predetermined bias voltage (a drive voltage, a writing voltage) to the display element 1 and applying any desired voltage waveform to the display element (between the electrodes) based on an input signal from the control circuit 16. It may have a high through rate. For example, a bipolar high-voltage amplifier, etc., may be used as the power supply device 17. The power supply device 17 will be described in detail in the section <Operation>, later.

The power supply device 17 applies voltage to the display element 1 between the electrodes 5 and 6 through the contact terminal 19.

### (Control Circuit)

The control circuit 16 is a member having a function of appropriately controlling the operation of the power supply device 17 and the light irradiation device 18 in response to image data from an external apparatus (an image capture apparatus, an image receiver, an image processing apparatus, an image reproduction apparatus, an apparatus having the functions of the above apparatuses, or the like). The control circuit 16 has functions independently from the control circuit for controlling the switching circuit described above, and controls writing of an image.

### (Entire Configuration)

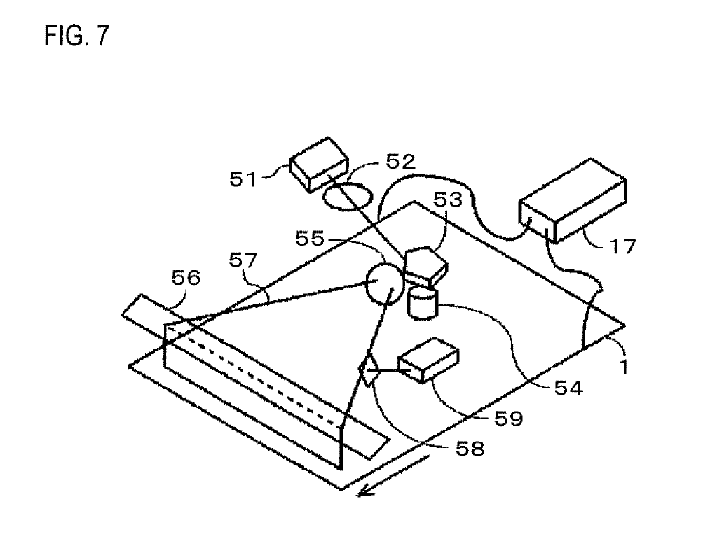

FIG. 7 is a perspective view showing an example of the driving device for the photo-addressable type display element according to this exemplary embodiment, and showing the case where a laser is used as the light irradiation unit. In FIG. 7, the control circuit 16 is not shown.

An exposure optical system (the light irradiation device 18) for applying light includes a semiconductor laser used as a light source 51, a collimator lens 52, a polygon mirror 53, a polygon motor 54, an f-θ lens 55 and a reflecting mirror 56. A laser beam 57 is supplied to a synchronizing signal generator 59 through a beam adjusting mirror 58 and used for synchronizing a scanning timing. A controller (the control circuit) of the driving device, which is not shown in the drawing, is the same as that of an ordinary laser exposure device for an electro-photography.

The display element 1 is fed in a sub-scanning direction by a pulse motor with the display element 1 being fixed in a flat state as shown in FIG. 7. Further, a substrate of the display element 1 is formed of a film to make the display element 1 flexible, so that the display element 1 can be fixed to a cylindrical drum and rotated by the motor.

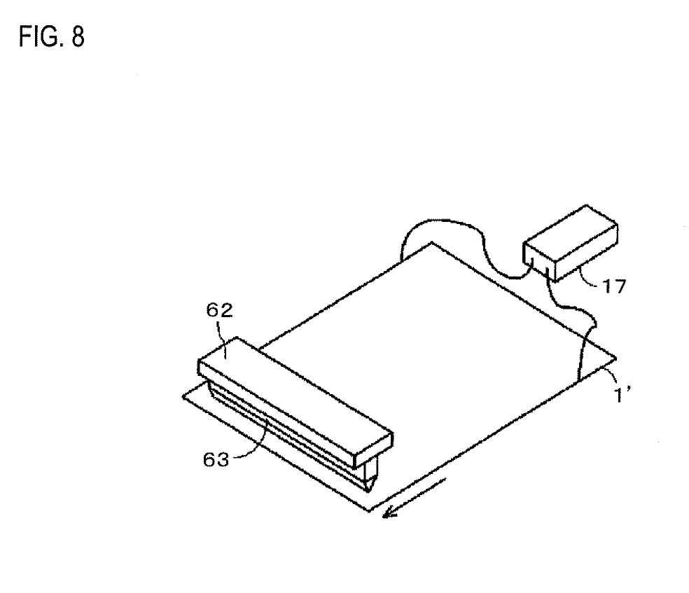

FIG. 8 shows another example of the driving device for the photo-addressable type display element according to this exemplary embodiment that uses a light emitting diode array as the light irradiation device. The configuration of the driving device is the same as the above-described example explained with reference to FIG. 7, except that a light source for applying light includes a light emitting diode array 62 and a self-image forming type rod lens array 63.

### <Operation>

In this exemplary embodiment, as described above, the liquid crystal layer of the self-holding type liquid crystal complex made of the cholesteric liquid crystal and the transparent resin is formed as the display layer 7.

In the display element 1 in this exemplary embodiment, the bistable phenomenon of the cholesteric liquid crystal is used to switch between (A) a selective reflection state caused by a planar state and (B) a transmission state caused by a focal conic state, by the light irradiation device 18 while the power supply device 17 is applying a predetermined bias voltage. Thereby, a display image having a memory property under no electric field is written into the display element 1.

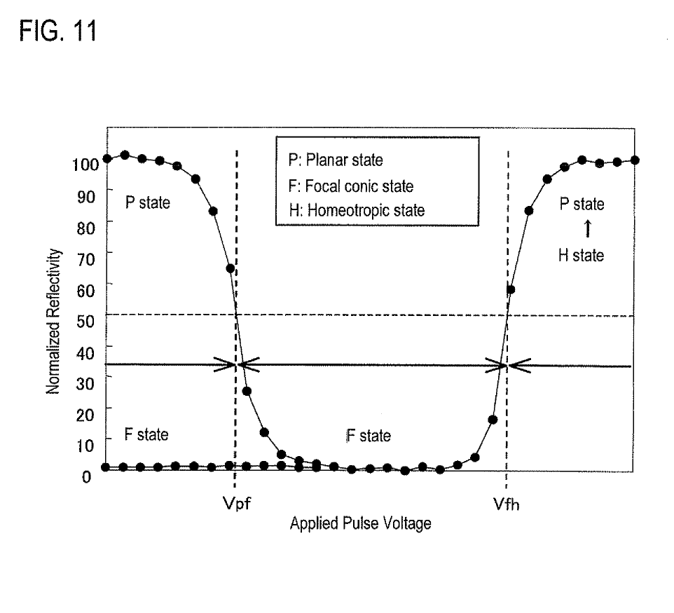

Description will be made with reference to FIG. 11.

In FIG. 11, the vertical axis is normalized light reflectivity. The light reflectivity is normalized so that the maximum light reflectivity is set to 100 and the minimum light reflectivity is set to 0. Since a transition region exists among the states of the planar state, the focal conic state, and the homeotropic state, the case where the normalized light reflectivity is 50 or more is defined as a selective reflection state, and the case where the normalized light reflectivity is less than 50 is defined as a transmission state. Also, a threshold voltage of a state change between the planar state and the focal conic state is denoted by Vpf, and a threshold voltage of state change between the focal conic state and the homeotropic state is denoted by Vfh.

The bias voltage applied by the power supply device 17, for example, is set so that, when a divided voltage in a range of Vpf to Vfh is applied to the display layer 7 while the light irradiation device 18 is applying address light having a predetermined wavelength and a predetermined intensity to the display layer 7, the divided voltage applied to the display layer 7 becomes Vfh or more. Under a state where such a bias voltage is applied, a part being in the planar (P) state shifts to the focal conic (F) state. A part being in the focal conic (F) state does not shift. Therefore, all parts shift to the focal conic (F) state.

Under this state, when the address light is selectively applied to the display element 1 by the light irradiation device 18, the divided voltage of Vfh or higher is applied only to the part to which the address is applied, and thereby the focal conic (F) state shifts to the homeotropic (H) state. Then, when the applied voltage is cancelled, the part to which the address light is applied to change its state to the homeotropic (H) state shifts to the selective reflection state caused by the planar (P) state. On the other hand, a part to which the address light is not applied maintains the focal conic (F) state as the transmission state. In such a way, the state is selectively changed to write an image.

In this exemplary embodiment, it is not especially limited which state change of the liquid crystal is used. Any state change may be used so long as, when the address light having the predetermined wavelength and the predetermined intensity is selectively applied to generate the state change and select the reflection/transmission, an image can be written. Also, in this exemplary embodiment, the following state change may be used. That is, the entire plane is brought into the planar (P) state in advance, for example, by applying the bias voltage of Vhf or higher and stopping the applying of the bias voltage. Then, the address light is selectively applied while a bias voltage, which is Vpf or less and will become Vfh or more when the address light having the predetermined wavelength and the predetermined intensity is applied, is being applied to the display layer 7, thereby changing a part to which the address light is applied to the focal conic (F) state. In this case, the part to which the address light is applied shifts the focal conic (F) state as the transmission state. A part to which the address light is not applied is in the planar (P) state as the selective reflection state. In such a way, the state is selectively changed to write an image.

In this exemplary embodiment, the power supply device 17 is one according to the exemplary embodiments, which can generate the bias voltage applied to a single stack unit. Also, the bias voltage is applied to the display element 1 by employing the voltage application method for the photo-addressable type display element according to the exemplary embodiments. Preferably, the power supply device of the first exemplary embodiment or the second exemplary embodiment is used as the power supply device 17.

### FIFTH EXEMPLARY EMBODIMENT

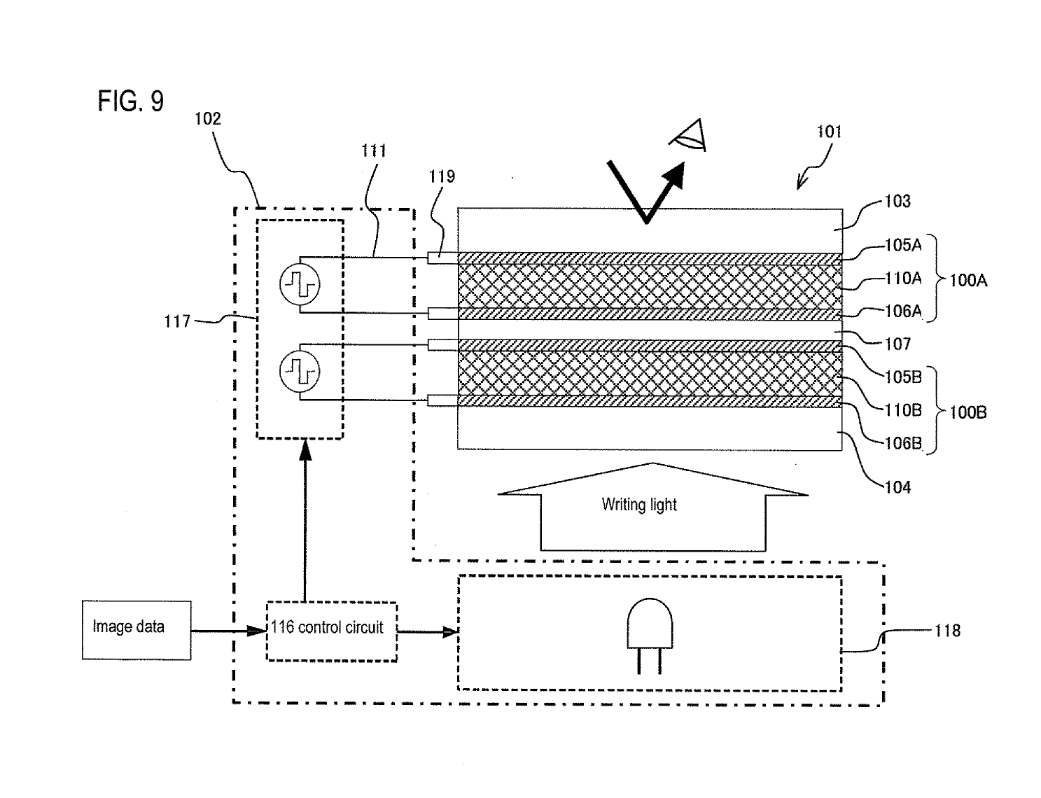

FIG. 9 is a schematic block diagram showing a system according to a fifth exemplary embodiment, including (i) a photo-addressable type display element having two stack units using a cholesteric liquid crystal and (ii) the entire part of a driving device according to the exemplary embodiments.

As shown in FIG. 9, the system of this exemplary embodiment includes a photo-addressable type display element 101 and a driving device (the driving device for the photo-addressable type display element) 102 for driving (writing an image into) the display element 101. The driving device 102 includes a power supply device (a voltage applying unit) 117, a light irradiation device (a light irradiation unit) 118 and a control circuit 116 for controlling operations of them.

### <Photo-Addressable Type Display Element>

In this exemplary embodiment, the display element (the photo-addressable type display element) 101 includes a substrate 103, a stack unit 100A, an intermediate substrate 107, a stack unit 100B and a substrate 104, which are stacked in order from a display surface side. The stack unit 100A and the stack unit 100B basically have the same layer configuration in which electrodes (electrode layers) 105A and 105B, photosensitive display layers 110A and 110B and electrodes (electrode layers) 106A and 106B are respectively stacked in order from the display surface side.

Although stacked states of the photosensitive display layers 110A and 110B are not shown in the figure, the photosensitive display layers 110A and 110B are equivalent to stack bodies including the display layer 7, the laminate layer 8, the coloring layer (shading layer) 9 and the organic photosensitive layer (photoconductive layer) 10 according to the fourth exemplary embodiment. In the following description, an explanation on the photosensitive layers 110A and 110 will be omitted, except for a structure peculiar to this exemplary embodiment. Since the substrate 103, the substrate 104, the electrodes 105A and 105B, the electrodes (electrode layers) 106A and 106B, contact terminals 119 and a conductive wire 111 basically have the same functions as those of the substrate 3) the substrate 4, the electrode 5, the electrode 6, the contact terminal 19 and the conductive wire 11 according to the fourth exemplary embodiment, an explanation thereon will be omitted.

As shown in FIG. 9, the display element 101 includes two stack units (100A, 100B) in each of which the organic photosensitive layer (photoconductive layer) and the display layer are stacked and sandwiched between the pair of the electrodes (electrode layer) 105A and 105B.

In the stack units, the included organic photosensitive layers (photoconductive layers) have sensitivities to light of different wavelengths from each other, and the included display layers are configured to display images having different hues.

The intermediate substrate 107 arranged between both the stack units 100A and 100B is the same as the substrates 103 and 104. The intermediate substrate 107 holds a shape and serves as an isolation member between the both stack units 100A and 100B. The intermediate layer 107 has a property of transmitting at least light having an absorption wavelength of the organic photosensitive layer (photoconductive layer) included in the stack unit 100A and light having a reflection wavelength of the display image of the display layer included in the stack unit 100B. Specific materials are the same as those of the substrates 3 and 4 described in the fourth exemplary embodiment.

Although not formed in this exemplary embodiment, a coloring layer (shading layer) that absorbs the light having the absorption wavelength of the organic photosensitive (photoconductive layer) included in the stack unit 100B may be formed between both the stack units 100A and 100B. This coloring layer is formed so that a good color separation can be realized during writing of an image, and can suppress an insufficient contrast or a color blur. Specific materials of the coloring layer are the same as those of the coloring layer 9 described in the fourth exemplary embodiment.

### <Driving Device for Photo-Addressable Type Display Element>

In this exemplary embodiment, the driving device 102 (the driving device for the photo-addressable type display element) 102 is a device for writing an image into the display element 101. The driving device 102 includes a light irradiation device (a light irradiation unit) 118 for applying address light to the display element 101, and a power supply device (a voltage applying unit) 117 for applying a bias voltage to the display element 101 as main components. The driving device 102 further includes a control circuit 116 for controlling operations of them.

### (Light Irradiation Device)

Any light irradiation device may be used as the light irradiation device (light irradiation unit or light irradiation unit) 118 so long as it has a function of applying address light patterns having different images and wavelengths for the respective stack units 100A and 100B simultaneously, and can apply a desired optical image pattern (spectrum, intensity, spatial frequency) to the display element 101 (specifically, to the organic photosensitive layers in the photosensitive display layers 110A and 110B) in accordance with an input signal from the control circuit 116.

The light irradiation device has the same configuration as that of the fourth exemplary embodiment, except that the light irradiation device is configured to apply the address light corresponding to the two stack units 100A and 100B simultaneously, detailed explanation thereon will be omitted.

### (Power Supply Device)

Any power supply device may be used as the power supply device (voltage applying unit) 117 so long as it has a function of applying a predetermined bias voltage (a driving voltage, a writing voltage) to the display element 101 and can apply a desired voltage waveform (a rectangular pulse waveform in this exemplary embodiment) to the display element (between the electrodes) in accordance with an input signal from the control circuit 116. In this case, the power supply device preferably has a high through rate. For examples, a bipolar high voltage amplifier may be used as the power supply device 117. The power supply device 117 has the configuration of the power supply device according to any one of the exemplary embodiments described above. Specifically, the power supply device 117 will be described in detail in the section of <Operation>.

Applying the voltage to the display element 101 by the power supply device 117 includes simultaneously applying the voltage, through the contact terminals 119, between the electrodes 105A and 106A and between the electrodes 105B and 106B.

### (Control Circuit)

The control circuit 116 is a member having a function of appropriately controlling the operations of the power supply device 117 and the light irradiation device 118 in accordance with image data from an external device (an image fetching device, an image receiving device, an image processor, an image reproducing device and a device having a plurality of functions of these devices). The control circuit 116 has a separate and independent function from the control circuit for controlling the switching circuit.

### (Entire Configuration)

In this exemplary embodiment, the entire configuration is different from that of the fourth exemplary embodiment in that images can be written into the two stack units 100A and 100B of the display element 101. However, since the remaining configuration is the same and an external appearance or an arrangement or the like does not need to be especially described, description on the remaining configuration will be omitted here (see the fourth exemplary embodiment).

### <Operation>

This exemplary embodiment is the same as the fourth exemplary embodiment in that the liquid crystal layer of a self-holding type liquid crystal complex made of the cholesteric liquid crystal and a transparent resin is formed as the display layers of the photosensitive display layers 110A and 110B and that the state change of the liquid crystal, the selection of the bias voltage and the address light and the functions of the bias voltage and the address light. Therefore, only an operation peculiar to this exemplary embodiment will be described below.

In this exemplary embodiment, the light irradiation device 118 applies to the display element 101 address light patterns having different images and different wavelengths for the respective stack units 100A and 100B simultaneously, while the power supply device 117 is applying the bias voltage between the electrode 105A and the electrode 106A and between the electrode 105B and the electrode 106B simultaneously. Then, state changes of the liquid crystal of the respective display layers of the stack units 100A and 100B are caused selectively and independently, thereby writing an image of two colors into the display element 101.

In this exemplary embodiment, the power supply device 117 is one that can apply the bias voltage to plural stack units simultaneously according to the above exemplary embodiments. The power supply device 117 applies the bias voltage to the stack units 100A and 100B of the display element 101 using the method for applying a voltage to the photo-addressable type display element according to the above exemplary embodiments. For example, the power supply device of the third exemplary embodiment may used as the power supply device 117. Since the voltage application method and the power supply device have already been described above, duplicated description thereon will be omitted.

As described above, when the power supply device that can apply a bias voltage to plural stack units simultaneously is used, a display element having plural stack units can be driven.

### SIXTH EXEMPLARY EMBODIMENT

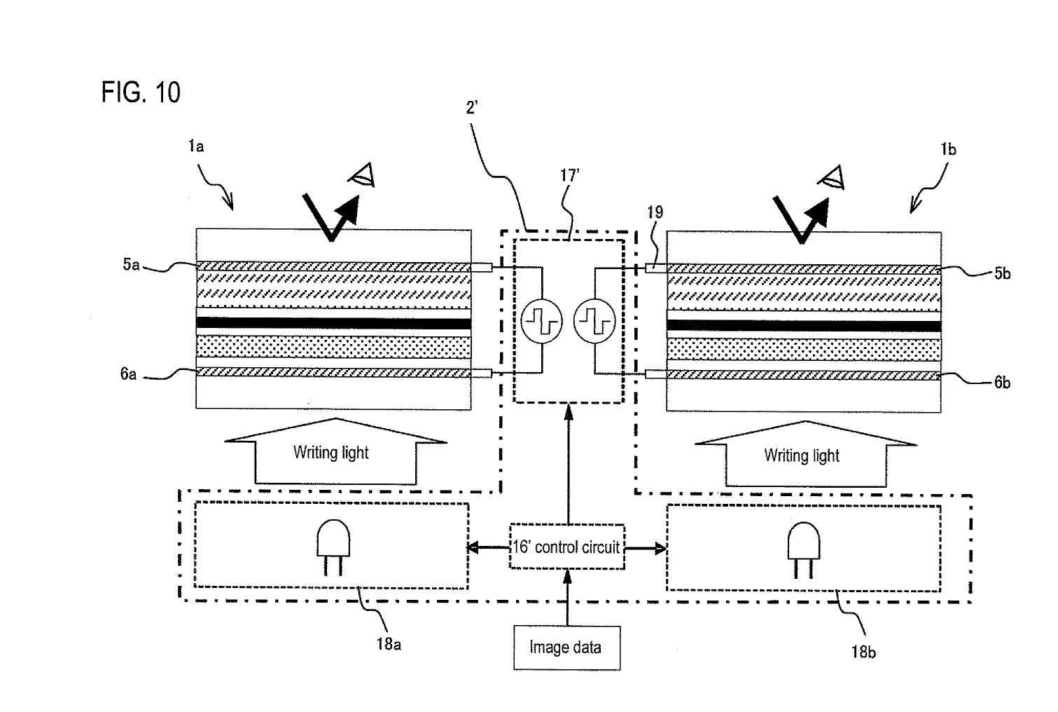

FIG. 10 is a schematic block diagram of a system according to a sixth exemplary embodiment, including (i) two photo-addressable type display elements each using a cholesteric liquid crystal and (ii) the entire part of a driving device. As shown in FIG. 9, the system of this exemplary embodiment includes the two photo-addressable type display elements 1a and 1b and the driving device (the driving device for the photo-addressable type display element) 2′ for driving (writing an image into) the display elements 1a and 1b. The driving device 2′ includes a power supply device (a voltage applying unit) 17′, two light irradiation devices (light irradiation units) 18a and 18b and a control circuit 16′ for controlling operations of them.

The system of this exemplary embodiment individually and independently drives the two display elements 1a and 1b to write images. Most part of this exemplary embodiment is configured by merely providing two constituent members each having the same configuration as that of the fourth exemplary embodiment. Accordingly, in FIG. 10, members having the same functions as those of the fourth exemplary embodiment are designated by the same reference numerals as those in FIG., 6 and “a” or “b” are attached to the ends thereof. Further, members partly different from those of the fourth exemplary embodiment or members having functions similar to those of the fourth exemplary embodiment are designated by the same reference numerals as those in FIG. 6 and “′” is attached thereto. Detailed explanation on these members will be omitted.

As described above, the display elements 1a and 1b respectively have the same configuration as that of the display element 1 of the fourth exemplary embodiment. Accordingly, the layer configuration is the same as that of the display element 1 of the fourth exemplary embodiment. Each of the display elements 1a and 1b has a single stack unit. Reference numerals for respective internal components of the display elements 1a and 1b are omitted, except a part of them.

The two display elements 1a and 1b are arranged in parallel to simultaneously write images by the driving device 2′. Namely, the light irradiation devices 18a and 18b applies imagewise address light to the display elements 1a and 1b while the power supply device (voltage applying unit) 17′ is applying bias voltages having the same waveforms the display elements 1a and 1b at the same timing. At this time, similarly to the fourth exemplary embodiment, the operations of the power supply device 17′ and the light irradiation devices 18a and 18b are appropriately controlled by the control circuit 16′ in accordance with image data from an external device. The timings of writing by the light irradiation devices 18a and 18b are caused to match each other. However, the images to be written can be made to be different from each other. It is to be understood that the images may be the same.

In this exemplary embodiment, the power supply device 17′ is a power supply device that can apply bias voltages to plural stack units simultaneously according to the above exemplary embodiments. The power supply device 17′ applies the bias voltage to the display elements 1a and 1b using the voltage application method for the photo-addressable type display element according to the above exemplary embodiments. For example, the power supply device of the third exemplary embodiment may be used as the power supply device 17′. Since the voltage application method and the power supply device have already been described above, duplicated explanation thereon will be omitted.

As described above, when the power supply device that can apply simultaneously a bias voltage to plural stack units is used, plural display elements each having a single stack unit can be driven simultaneously.

The driving device for the photo-addressable type display element has been described with reference to the three exemplary embodiments, that is, the fourth to sixth exemplary embodiments. However, the invention is not limited thereto. For example, in the above-described exemplary embodiments, the configuration for driving one and two display elements each including only a single stack unit or the configuration for driving a single display element including two stack units are exemplified. However, three or more display elements each including only a single stack units, two or more display elements each including two stack units, or one or two display elements each including three or more stack units may be driven simultaneously. In these cases, the power supply device that can output pulse voltages corresponding to the number of stack units to be driven is employed.

### EXAMPLE

Now, the exemplary embodiments of the invention will be specifically described with reference to examples. It is noted that the invention is not limited to the following examples.

### Example 1

In Example 1, a display element having substantially the same configuration as that of the display element shown in FIG. 6 is manufactured for trial. The system shown in FIG. 6 is assembled to write an image into the display element. Explanation will be given below with reference to FIG. 6.

### <Manufacture of Display Element>

### (Preparation of Application Solution for Display Layer>

A nematic liquid crystal (E7, produced by Merck Ltd.) of 77.5 mass %, a chiral agent 1 (CB 15, produced by Merck Ltd.) of 18.8 mass %, a chiral agent 2 (R1011, produced by Merck Ltd.) of 3.7 mass % are mixed together to prepare a cholesteric liquid crystal selectively reflecting green light.

A 3:1 addition material of xylene diisocyanate and trimethylol propane (Takenate D110N produced by Takeda Pharmaceutical Company Limited) of ⅕ mass parts of the cholesteric liquid crystal and ethyl acetate of ⅕ mass parts of the cholesteric liquid crystal are added to the obtained cholesteric liquid crystal, and are agitated to obtain uniform solution in an oil phase.

Ethyl acetate of 1 mass parts is added to 1.0 mass % aqueous solution of partly suspended polyvinyl alcohol (PVA, degree of polymerization of 500, produced by Wako Pure Chemical Industries, Ltd.) of 10 mass parts. The obtained solution is agitated at 70° C. and cooled at a room temperature. The ethyl acetate that is be dissolved and separated is removed to obtain uniform solution in an aqueous phase.

The oil phase is emulsified in the aqueous phase under the condition of nitrogen pressure of 9.8 kPa (0.10 kgf/cm²) using a film emulsifier (Microkit, produced by SPG Technology Co., Ltd.) in which a ceramic porous film having a dimeter of 4.2 μm is set.

The obtained emulsion is in a state near to a mono-disperse in which the average particle diameter (number basis) of an oil droplet is 15.7 μm, and a standard deviation of the particle diameter is 1.81 μm.

Then, 1 g of 10 mass % 1, 4-butanediol aqueous solution is dripped to the obtained emulsion and is agitated for 90 minutes at 70° C. to carry out a polymerization reaction to obtain a slurry type liquid crystal micro-capsule dispersion solution in which the cholesteric liquid crystal is wrapped by a shell of a urethane urea resin. The averaged particle diameter (number reference) of the liquid crystal micro-capsule is 14.3 μm.

The obtained liquid crystal micro-capsule dispersion solution is diluted by a large quantity of water. Then, the liquid crystal micro-capsules are sunk using a centrifugal separator, and supernatant liquid is removed to obtain a thick liquid crystal micro-capsule dispersion solution. The above-described operation is repeated two times to obtain a concentrated liquid crystal micro-capsule dispersion solution with polyvinyl alcohol and ethyl acetate removed. When a volume ratio of the liquid crystal micro-capsule in the concentrated liquid crystal micro-capsule dispersion solution is measured using a densitometer (DMA 35n, produced by Nihon SiberHegner K.K.), the volume ratio is 0.505.

3.7 mass parts of 7.8 mass % aqueous solution of acid gelatin (jelly strength of 314 g/sol viscosity of 32 mp, produced by Nippi Co., Ltd.) is added to 1 mass part of the concentrated liquid crystal micro-capsule dispersion solution to obtain an application solution for a display layer in which the volume ratio of a non-volatile component in the application solution for the display layer is about 0.15, and the volume ratio of the micro-capsule in the non-volatile component is about 0.70.

The application solution for the display layer in which the gelatin is heated to 50° C. to bring the gelatin to a sol state is applied to the surface of an ITO side of a PET display substrate (a substrate 3, High Beam, produced by Toray Industries, Inc.) with the thickness of 125 μm on which an ITO transparent electrode as an electrode 5 is sputtered by an applicator having a micro meter in which a gap is adjusted so that the thickness of a wet film after the application solution is applied is 90 μm.

Subsequently, the substrate to which the application solution for the display layer is applied is mounted on a ultrasonic vibrating plate (U1304, produced by Sharp Corporation) through dimethyl silicon oil (KF 96, produced by Shin-Etsu Chemical Co., Ltd.). The substrate is covered with a polystyrene case, and is held in an oven of 50° C. for 15 minutes by applying a vibration thereto. An applied film after the application solution is dried exhibited the planar orientation of the cholesteric crystal due to the contraction of the film to the direction of the thickness at the time of drying and a selective reflected light of green color. In such a way, a display layer 7 on which the cholesteric liquid crystal micro-capsules are densely arranged on a single layer is formed, and a display layer side substrate is obtained.

On the other hand, as a substrate of an opposed side, a glass substrate (substrate 4, produced by EHC Co., Ltd.) having the thickness of 1.1 μm on which an ITO transparent electrode as an electrode 6 is sputtered is used. To the surface of an ITO side, by using butanol as a solvent, a solution in which 1.2 mass % of titanyl phthalocyanine pigment having a high sensitivity to a visible light of 600 nm or more and 0.8 mass % of polyvinyl butyral are dispersed is applied by a spin coating (a charge generation layer 15 later) so as to have the thickness of the film of 200 nm. Further, a solution in which 9.0 mass % of N,N′-bis(3-methyl phenyl)-1,1′-biphenyl-4,4′-diamine and 6.0 mass % of bis phenol Z polycarbonate are dispersed using monochloro benzene as a solvent is applied thereon so as to have the thickness of a film of 3 μm by a spin coating (a charge transport layer 14, later). Further, by using butanol as a solvent, a solution in which 3.0 mass % of titanyl phthalocyanine pigment having a high sensitivity to a visible light of 600 nm or more and 2.0 mass % of polyvinyl butyral are dispersed is applied thereon by a spin coating (a charge generation layer 13 later) so as to have the thickness of the film of 200 nm, and the applied film is dried and hardened to form an organic photosensitive layer 10.

Further, on the organic photosensitive layer 10, 7.4 mass % of aqueous solution in which 1.3 mass % of polyvinyl alcohol is dispersed to all the amount of carbon black pigment is applied by a spin coating to have the thickness of the film of 2.0 μm and form a shading layer (coloring layer). A urethane type laminate agent (X719/KY-90, produced by Dainippon Ink and Chemicals, Inc.) is applied thereon by a spin coating so as to have the thickness of 1 μm and form an adhesive layer (a laminte layer 8), and a photoconductive layer side substrate is obtained.

The display layer side substrate and the photoconductive layer side substrate manufactured in such a way are overlapped so that the display layer 7 faced the laminate layer 8 and end faces are partly shifted, stuck to each other through a laminator of 100° C. to obtain a display element 1 used in this example and a comparative example. Each functional film on the shifted end face is removed to expose the ITO electrode so that both the electrodes can be electrically conducted from an external part of a finally obtained display element 1.

Marketed basketwork type clips (contact terminal 19) having lead wires are connected to both the electrodes 5 and 6 of the obtained display element 1 and the other ends of the lead wires are connected to the power supply device 17. The poser supply device 17 use a DC-DC converter {ETZKSBXP1BA (positive side) and ETZKSBXN1BA (negative side)} produced by Panasonic Corporation as an output converter and this output converter is connected to the switching circuit of the circuit diagram shown in FIG. 2. The lead wires are connected to the output terminal of the switching circuit.

The power supply device 17 is set so that the output voltage from the output converter is ±500 volt, and the frequency of a rectangular wave pulse synthesized by the switching element is set to 50 Hz (20 ms in a pulse width). The power supply device 107 is also set so as to apply a rectangular wave pulse that renders a time for holding “the output voltage of the output converter, which is not selected after a switching operation, to 0 volt”, which is equivalent to a time for allowing the rectangular wave pulse to pass through the ground level, to be 1 ms.

On the other hand, as a light source, the light irradiation device 18 is configured by using a color light emitting diode light source (produced by CCS Co., Ltd., HLV-27-NR-R type) so that a non-display surface (a surface of a writing side) can be irradiated with light. With this light irradiation device 18, red light having a peak wavelength of 625 nm and a band half width of 20 nm can be applied.

Furthermore, as the control circuit 16, a multi-channel DAQ board (6713 type produced by National Instruments Co., Ltd.) and control software (LabVIEW produced by National Instruments Co., Ltd.) are used and wired so as to suitably control the operations of the power supply device 17 and the light irradiation device 18 in accordance with image data from a personal computer.

Although not shown in the figures, an integrating spherical spectrometer (CM 2002 type produced by Konica Minolta Sensing Inc.) for measuring a light reflectivity of the display image of the display layer 7 is attached onto the surface of the display surface side (the substrate 3 side) of the display element 1.

In such a way, a drive evaluating system including the display element 1 and the driving device 2 used in the example 1 is manufactured.

Using this obtained system, the above-described rectangular waved pulse is applied to the electrodes 5 and 6 of the display element 1 for 400 ms. Under this state, address light of 500 μW/cm² is applied to the electrodes. The reflectivity of the display surface of the display element 1 after the light is applied is measured by the integrating spherical spectrometer (CM 2002 type produced by Konica Minolta Sensing Inc.). The obtained measured value of the reflectivity is 25% which is an adequate reflectivity.

Further, when the address light is applied to an image by the light irradiation device 18, a clear display image is formed.

In the pulse generating unit PGU 1 of the circuit diagram shown in FIG. 2, only two field effect transistors (FET 11 and FET 12) whose withstanding voltage is 600 volt are included in the switching circuits (SWC 11 and SWC 12) for generating the pulse. Even when the field effect transistors (FET 13 and FET 14) included in the ground switching circuit SWG 13 for adjusting the output voltage to the ground voltage when a voltage application operation is finished are added thereto, the number of the field effect transistors may be four in total. Thus, the switching circuits (SWC1, SWC 2) can formed with a simple configuration, the power supply device can be miniaturized, the cost can be reduced and the clear display image can be formed as described above.

### Comparative Example 1

A system is operated to measure a reflectivity in the same manner as that of the example 1 except that the members of the circuit diagram shown in FIG. 2 are replaced with the members of the circuit diagram shown in FIG. 15 as a switching circuit of a power supply device 17, and that the output voltage of ±500 volt from an output converter is set to be switched in accordance with the method of the related art and to synthesize a rectangular wave pulse of 50 Hz (20 ms in a pulse width). As a result, the reflectivity is 25% which is the same as that of the example 1. Further, when an address light is applied to an image similarly to the example 1, a clear display image is formed.

However, in the switching circuit of the circuit diagram shown in FIG. 15, field effect transistors having the withstanding voltage of 1,200 volt are used (precisely, two field effect transistors of the withstanding voltage of 600 volt are arranged in parallel). Thus, a power supply device and a driving device are further enlarged, and a cost is higher than those of the example 1 [Example 2]

In Example 2, as a display element that can be applied to the invention, two display elements 1 used in the Example 1 are prepared and they are used as the display elements 1a and 1b, and a system is assembled as shown in FIG. 10 to write an image. Now, the above-described operation will be stated below.

Marketed basketwork type clips (contact terminal 19) having lead wires are connected to both the electrodes 5a and 6a and 5b and 6b of the display elements 1a and 1b, and the other ends of the lead wires are connected to the power supply device 17′. The power supply device 17′ uses a DC-DC converter {ETZKSBXP1BA (positive side) and ETZKSBXN1BA (negative side)} produced by Panasonic Corporation as an output converter, and these output converters are connected to the switching circuits of the circuit diagram shown in FIG. 5. The lead wires are connected to the output terminals A and B of the switching circuit.

The power supply device 17′ is set so that the output voltage from the output converter is ±500 volt and the frequency of a rectangular wave pulse synthesized by the switching element is 50 Hz (20 ms in a pulse width). The power supply device 17′ is also set so as to apply the rectangular wave pulse to both the display elements 1a and 1b. The rectangular wave pulse renders a time for holding “the output voltage of the output converter, which is not selected after a switching operation, to 0 volt”, which is equivalent to a time for allowing the rectangular wave pulse to pass through the ground level, to be 1 ms.

On the other hand, as the light irradiation devices 18a and 18b, the same device as the light irradiation device 18 in the example 1 is used under the same condition. Further, as the control circuit 16′, the same control circuit as the control circuit 16 in the Example 1 is used and wired to suitably control the operations of the power supply device 17′ and the light irradiation devices 18a and 18b.

Although not shown in the figures, integrating spherical spectrometers (CM 2002 type produced by Konica Minolta Sensing, Inc.) for measuring a light reflectivity of the display image of the display layer are respectively attached onto the surfaces of the display surface sides (electrode 5a and 5b side) of the display elements 1a and 1b.

In such a way, a drive evaluating system including the display element 1 and the driving device 2 used in the example 1 is manufactured.

Using the obtained system, the above-described rectangular waved pulse is applied to the electrodes 5a and 5b and 6a and 6b of the display elements 1a and 1b for 400 ms. Under this state, an address light of 500 μW/cm² is applied to the electrodes. The reflectivity of the display surface of the display elements 1a and 1b after the light is applied is measured by the integrating spherical spectrometers (CM 2002 type produced by Konica Minolta Sensing, Inc.). The obtained measured value of the reflectivity is 25% which is an adequate reflectivity.

Further, when the address light is applied to images by the light irradiation devices 18a and 18b, clear display images are formed on both the display elements 1a and 1b.

In the pulse generating units PGU 3A and PGU 3B of the circuit diagram shown in FIG. 5, only four field effect transistors (FET 31A, FET 32A, FET 31B and FET 32B) whose withstanding voltage is 600 volt are included in total in the switching circuits (SWC 31A, SWC 32A, SWC 31B and SWC 32B) for generating a pulse.

Further, the positive and negative power source control switching circuits SWG 33 and SWG 34 are commonly used for the two pulse generating units PGU 3A and PGU 3B. Even when the field effect transistors (FET 33 and FET 34) are included in the positive and negative power source control switching circuits are added to the above-described field effect transistors, the number of the field transistors is six in total. Therefore, the switching circuits (SWC 31A, SWC 32A, SWC 31B and SWC 32B) can be constructed by a simple configuration, the power supply device and the driving device can be miniaturized, a cost can be reduced and the clear images can be formed as described above.

What is claimed is:

1. A method for applying a voltage to a photo-addressable type display element into which an image is written by applying a bias voltage while applying address light thereto, the method comprising:
switching between a dc voltage of +V volt and a dc voltage of −V volt by a switching circuit including a switching element that switches between the dc voltage of +V volt and the dc voltage of −V volt, which are output from output converters, respectively, to synthesize a rectangular wave pulse of ±V volt; and
applying the rectangular wave pulse of ±V volt to the photo-addressable type display element, as the bias voltage, wherein
when the rectangular wave pulse is to be switched from one of +V volt and −V volt to the other, (i) the rectangular wave is grounded in the course of the switching from the one of +V volt and −V volt to the other, (ii) an output voltage of the output converter, which is not selected after the switching of the rectangular pulse, is changed to about 0 volt, and then, (iii) the rectangular wave pulse is changed to the other of +V volt and −V volt.

2. The method according to claim 1, wherein the switching element, which switches between the two kinds of dc voltages, includes a protection diode.

3. A power supply device comprising:
a positive output converter that outputs a dc voltage of +V volt;
a negative output converter that outputs a dc voltage of −V volt; and
a pulse generating unit including
a positive switching circuit having a switching element that switches the dc voltage of +V volt output from the positive output converter, and
a negative switching circuit having a switching element that switches the dc voltage of −V volt; output from the negative output converter, wherein
when an image is written into a photo-addressable type display element including a stack unit, in which a photoconductive layer and a display layer are stacked and sandwiched between a pair of electrode layers, by applying a bias voltage between the pair of electrode layers while applying address light, switching is made between the de voltage of +V volt and the dc voltage of −V volt by the positive and negative switching circuits of the pulse generating unit to synthesize a rectangular wave pulse of ±V volt, and the rectangular wave pulse is applied between the pair of electrode layers as the bias voltage,
when the rectangular wave pulse is to be switched from one of +V volt and −V volt to the other in the pulse generating unit, (i) the rectangular wave is grounded in the course of the switching from the one of +V volt and −V volt to the other, (ii) an output voltage of one of the positive and negative output converters, which is not selected after the switching of the rectangular pulse, is changed to about 0 volt; and then, (iii) the rectangular wave pulse is changed to the other of +V volt and −V volt.

4. The power supply device according to claim 3, wherein each of the switching elements included in the pulse generating unit has a protection diode.

5. The power supply device according to claim 3, further comprising:
a positive power source control switching circuit including
a switching element configured to switch the output voltage of the positive output converter, which outputs the dc voltage of +V volt, between +V volt and about 0 volt,
the positive power source control switching unit being arranged between the positive output converter and the positive switching circuit, which switches the output voltage of the positive output converter; and
a negative power source control switching circuit including
a switching element configured to switch the output voltage of the negative output converter, which outputs the dc voltage of −V volt, between −V volt and about 0 volt,
the negative power source control switching unit being arranged between the negative output converter and the negative switching circuit, which switches the output voltage of the negative output converter, wherein
a corresponding one of the positive and negative power source control switching circuits changes the output voltage of the one of the positive and negative output converters, which is not selected after the switching of the rectangular wave pulse, to about 0 volt.

6. The power supply device according to claim 4, further comprising:
a positive power source control switching circuit including
a switching element configured to switch the output voltage of the positive output converter, which outputs the dc voltage of +V volt, between +V volt and about 0 volt,
the positive power source control switching unit being arranged between the positive output converter and the positive switching circuit, which switches the output voltage of the positive output converter; and
a negative power source control switching circuit including
a switching element configured to switch the output voltage of the negative output converter, which outputs the dc voltage of −V volt, between −V volt and about 0 volt,
the negative power source control switching unit being arranged between the negative output converter and the negative switching circuit, which switches the output voltage of the negative output converter, wherein
a corresponding one of the positive and negative power source control switching circuits changes the output voltage of the one of the positive and negative output converters, which is not selected after the switching of the rectangular wave pulse, to about 0 volt.

7. The power supply device according to claim 5, comprising:
a plurality of the pulse generating units configured to synthesize the rectangular wave pulses, respectively and to simultaneously apply the rectangular wave pulses between the pairs of electrode layers of the different stack units, respectively, wherein
the single positive power source control switching circuit is connected to all the positive switching circuits of the plurality of pulse generating units, and
the single negative power source control switching circuit is connected to all the negative switching circuits of the plurality of pulse generating units.

8. The power supply device according to claim 6, comprising:
a plurality of the pulse generating units configured to synthesize the rectangular wave pulses, respectively and to simultaneously apply the rectangular wave pulses between the pairs of electrode layers of the different stack units, respectively, wherein
the single positive power source control switching circuit is connected to all the positive switching circuits of the plurality of pulse generating units, and
the single negative power source control switching circuit is connected to all the negative switching circuits of the plurality of pulse generating units.

9. A driving device for a photo-addressable type display element, wherein
the photo-addressable type display element includes a stack unit in which a photoconductive layer a display layer are stacked and sandwiched between a pair of electrode layers,
at least one of the electrode layers, which is disposed on a display side, is transparent,
the photoconductive layer absorbs light in a specific wavelength band and changes an electric characteristic thereof in accordance with an amount of the absorbed light, and
the display layer configured to transmit or reflect light to form a display image, the driving device comprising:
a voltage applying unit that applies a voltage between the pair of electrode layers of the photo-addressable type display element; and
an address light irradiation unit that applies address light from the display side or a back surface side of the photo-addressable type display element, wherein
the voltage applying unit includes the power supply device according to claim 3.

10. The driving device according to claim 9, wherein the display layer of the photo-addressable type display element includes a cholesteric liquid crystal and transmits or reflects the light in accordance with change of a state of the cholesteric liquid crystal to form the display image.

11. A driving device for a photo-addressable type display element, wherein
the photo-addressable type display element includes a stack unit in which a photoconductive layer a display layer are stacked and sandwiched between a pair of electrode layers,
at least one of the electrode layers, which is disposed on a display side, is transparent,
the photoconductive layer absorbs light in a specific wavelength band and changes an electric characteristic thereof in accordance with an amount of the absorbed light, and
the display layer configured to transmit or reflect light to form a display image, the driving device comprising:
a voltage applying unit that applies a voltage between the pair of electrode layers of the photo-addressable type display element; and
an address light irradiation unit that applies address light from the display side or a back surface side of the photo-addressable type display element, wherein
the voltage applying unit includes the power supply device according to claim 4.

12. The driving device according to claim 11, wherein the display layer of the photo-addressable type display element includes a cholesteric liquid crystal and transmits or reflects the light in accordance with change of a state of the cholesteric liquid crystal to form the display image.

13. A driving device for a photo-addressable type display element, wherein
the photo-addressable type display element includes a stack unit in which a photoconductive layer a display layer are stacked and sandwiched between a pair of electrode layers,
at least one of the electrode layers, which is disposed on a display side, is transparent,
the photoconductive layer absorbs light in a specific wavelength band and changes an electric characteristic thereof in accordance with an amount of the absorbed light, and
the display layer configured to transmit or reflect light to form a display image, the driving device comprising:
a voltage applying unit that applies a voltage between the pair of electrode layers of the photo-addressable type display element; and
an address light irradiation unit that applies address light from the display side or a back surface side of the photo-addressable type display element, wherein
the voltage applying unit includes the power supply device according to claim 5.

14. The driving device according to claim 13, wherein the display layer of the photo-addressable type display element includes a cholesteric liquid crystal and transmits or reflects the light in accordance with change of a state of the cholesteric liquid crystal to form the display image.

15. A driving device for a photo-addressable type display element, wherein
the photo-addressable type display element includes a stack unit in which a photoconductive layer a display layer are stacked and sandwiched between a pair of electrode layers,
at least one of the electrode layers, which is disposed on a display side, is transparent,
the photoconductive layer absorbs light in a specific wavelength band and changes an electric characteristic thereof in accordance with an amount of the absorbed light, and
the display layer configured to transmit or reflect light to form a display image, the driving device comprising:
a voltage applying unit that applies a voltage between the pair of electrode layers of the photo-addressable type display element; and
an address light irradiation unit that applies address light from the display side or a back surface side of the photo-addressable type display element, wherein
the voltage applying unit includes the power supply device according to claim 6.

16. The driving device according to claim 15, wherein the display layer of the photo-addressable type display element includes a cholesteric liquid crystal and transmits or reflects the light in accordance with change of a state of the cholesteric liquid crystal to form the display image.

17. A driving device for a photo-addressable type display element, wherein
the photo-addressable type display element includes a plurality of stack units in each of which a photoconductive layer a display layer are stacked and sandwiched between a pair of electrode layers,
at least one of electrode layers of each pair, which is disposed on a display side, is transparent,
each photoconductive layer absorbs light in a specific wavelength band and changes an electric characteristic thereof in accordance with an amount of the absorbed light, and
each display layer configured to transmit or reflect light to form a display image, the driving device comprising:
a voltage applying unit that applies a voltage between each pair of electrode layers of the photo-addressable type display element; and
an address light irradiation unit that applies address light from the display side or a back surface side of the photo-addressable type display element, wherein
the address light irradiation unit applies the address light from the display side or the back surface side of the photo-addressable type display element while the voltage applying unit is simultaneously applying the voltages between the pairs of electrode layers of at least two of the stack units, and
the voltage applying unit includes the power supply device according to claim 7.

18. The driving device according to claim 17, wherein the display layer of the photo-addressable type display element includes a cholesteric liquid crystal and transmits or reflects the light in accordance with change of a state of the cholesteric liquid crystal to form the display image.

19. A driving device for a photo-addressable type display element, wherein
the photo-addressable type display element includes a plurality of stack units in each of which a photoconductive layer a display layer are stacked and sandwiched between a pair of electrode layers,
at least one of electrode layers of each pair, which is disposed on a display side, is transparent,
each photoconductive layer absorbs light in a specific wavelength band and changes an electric characteristic thereof in accordance with an amount of the absorbed light, and
each display layer configured to transmit or reflect light to form a display image, the driving device comprising:
a voltage applying unit that applies a voltage between each pair of electrode layers of the photo-addressable type display element; and
an address light irradiation unit that applies address light from the display side or a back surface side of the photo-addressable type display element, wherein
the address light irradiation unit applies the address light from the display side or the back surface side of the photo-addressable type display element while the voltage applying unit is simultaneously applying the voltages between the pairs of electrode layers of at least two of the stack units, and
the voltage applying unit includes the power supply device according to claim 8.

20. The driving device according to claim 19, wherein the display layer of the photo-addressable type display element includes a cholesteric liquid crystal and transmits or reflects the light in accordance with change of a state of the cholesteric liquid crystal to form the display image.
